(19) United States
(12) Patent Application Publication
(10) Pub. No.: US 2026/0146151 A1
(43) Pub. Date: May 28, 2026

(54) ALPHA-NUCLEATED PROPYLENE/ETHYLENE/1-BUTENE TERPOLYMER COMPOSITIONS FOR BLOWN AND CAST FILMS

(71) Applicant: BOREALIS AG, Vienna (AT)

(72) Inventors: Jingbo Wang, Linz (AT); Francisco Sacchetti, Linz (AT); Joel Fawaz, Linz (AT); Markus Gahleitner, Linz (AT); Klaus Bernreitner, Linz (AT); Peter Niedersüss, Linz (AT); Stefan Ortner, Linz (AT); Auli Nummila-Pakarinen, Kullo (FI)

(21) Appl. No.: 19/105,162

(22) PCT Filed: Aug. 22, 2023
(86) PCT No.: PCT/EP2023/073021

§ 371 Date: Feb. 20, 2025

(30) Foreign Application Priority Data
Aug. 23, 2022 (EP) 2219164.2

(51) Int. Cl. C08L 23/20; C08F 2/01; C08F 4/649; C08F 4/659; C08F 4/6592; C08F 210/08; C08K 3/26; C08K 5/00; C08K 5/134; C08K 5/14; C08K 5/524

(52) U.S. Cl. CPC C08L 23/20; C08F 2/01; C08F 4/6493; C08F 4/65916; C08F 4/65927; C08F 210/08; C08K 3/26; C08K 5/0083; C08K 5/1345; C08K 5/14; C08K 5/524; C08K 2003/267; C08L 2203/162; C08L 2205/025; C08L 2314/06

(57) ABSTRACT

An alpha-nucleated monophasic propylene terpolymer composition (PC) having an ethylene content in the range from 0.75 to 4.0 mol-%, a 1-butene content in the range from 2.0 to 7.5 mol-%, an MFR₂ in the range from 1.0 to 35 g/10 min, a melting temperature in the range from 125 to 140° C., and a crystallization temperature in the range from 95 to 115° C., wherein the alpha-nucleated monophasic propylene terpolymer composition (PC) furthermore has: a) a 1.5 N Hot Tack sealing process window, measured on a 50 m blown film sample, in the range from 15 to 25° C., or b) a 1.5 N Hot Tack sealing process window, measured on a 50 m cast film sample, in the range from 20 to 30° C.

### FIELD OF THE INVENTION

The present invention relates to an alpha-nucleated monophasic propylene terpolymer composition (PC), articles, especially films, comprising said composition and a process for producing said composition.

### BACKGROUND TO THE INVENTION

Propylene/ethylene/1-butene terpolymers represent the gold standard for film applications when low sealing initiation temperatures (SIT), high hot tack forces and low extractables (for safety in the food industry) are required. This combination of desirable features is extremely difficult to achieve for other types of polyolefins.

It is well-known that the most straightforward way to improve (i.e. lower) the SIT is to add higher amounts of comonomers, in particular 1-butene; however, it is also well-known that this would lead to a higher xylene-soluble fraction (XCS) and therefore higher extractables. Also of importance is the mechanical performance of the films, especially during sealing, while the seal of the food package is still hot (i.e. so-called hot tack properties). Providing a balance between mechanical and sealing properties represents a challenge where further progress may be made in terpolymer compositions for film applications.

At present, many of these problems may be overcome by employing multilayer films; however, these multilayer films are disadvantageous for reasons of process economy, in addition to the fact that they are much more difficult to recycle. As such, light weight, simple solutions are required in the field of films used for sealing.

In general, it is known that standard nucleating/clarifying agents, such as sorbitol- and nonitol-derivatives can contribute to the improvement of mechanical properties of films; however, the same increased crystallization typically leads to higher sealing initiation temperatures, which is undesirable. As such, it is a goal of the present invention to provide nucleated compositions wherein the improved mechanical properties may be obtained without sacrificing the sealing and/or optical properties in order to obtain the improvements in the mechanical properties.

### SUMMARY OF THE INVENTION

The present invention is based upon the finding that the combination of certain propylene/ethylene/1-butene terpolymers with certain alpha nucleating agents affords compositions that can be formed into films that unexpectedly balance improved mechanical and optical properties without sacrificing sealing properties, in particular having a broad temperature window, over which good sealing properties may be achieved.

In a first aspect, the present invention is directed to an alpha-nucleated monophasic propylene terpolymer composition (PC), comprising:
a) a propylene/ethylene/1-butene random terpolymer (PP), having:
   i) an ethylene content (C2), as determined by quantitative ¹³C-NMR spectroscopy, in the range from 0.75 to 4.0 mol-%;
   ii) a 1-butene content (C4), as determined by quantitative ¹³C-NMR spectroscopy, in the range from 2.0 to 7.5 mol-%; and
   iii) a content of 2,1-regiodefects, as determined by quantitative ¹³C-NMR spectroscopy analysis, in the range from 0.1 to 1.5 mol-%, and
b) one or more alpha nucleating agents (NU), wherein at least one of the one or more alpha nucleating agents is a particulate alpha nucleating agent,
   wherein the total amounts of the propylene/ethylene/1-butene random terpolymer (PP) and the one or more alpha nucleating agents (NU) add up to at least 95 wt.-% of the total weight of the alpha-nucleated monophasic propylene terpolymer composition (PC),
   wherein the alpha-nucleated monophasic propylene terpolymer composition (PC) has each of the following properties:
i) a melt flow rate (MFR₂), determined according to ISO 1133 at 230° C. at a load of 2.16 kg, in the range from 1.0 to 35 g/10 min;
ii) a melting temperature, determined according to DSC analysis, in the range from 125 to 140° C.; and
iii) a crystallization temperature, determined according to DSC analysis, in the range from 95 to 115° C.

In a second aspect, the present invention is directed to an alpha-nucleated monophasic propylene terpolymer composition (PC) having:
i) an ethylene content (C2), as determined by quantitative ¹³C-NMR spectroscopy, in the range from 0.75 to 4.0 mol-%;
ii) a 1-butene content (C4), as determined by quantitative ¹³C-NMR spectroscopy, in the range from 2.0 to 7.5 mol-%;
iii) a melt flow rate (MFR₂), determined according to ISO 1133 at 230° C. at a load of 2.16 kg, in the range from 1.0 to 35 g/10 min;
iv) a melting temperature, determined according to DSC analysis, in the range from 125 to 140° C.; and
v) a crystallization temperature, determined according to DSC analysis, in the range from 95 to 115° C.,
   wherein the alpha-nucleated monophasic propylene terpolymer composition (PC) furthermore has:
a) a 1.5 N Hot Tack sealing process window, measured on a 50 μm blown film sample, in the range from 15 to 25° C., or
b) a 1.5 N Hot Tack sealing process window, measured on a 50 μm cast film sample, in the range from 20 to 30° C.

In a third aspect, the present invention is directed to a process for producing the alpha-nucleated monophasic propylene terpolymer composition (PC) according to either of the first two aspects, comprising the steps of:
a) polymerizing propylene, ethylene and 1-butene comonomer units in a first polymerization reactor in the presence of a single-site catalyst to produce a first polymerization mixture comprising the first random terpolymer fraction (PP1) and the single-site catalyst, wherein the first polymerization reactor is preferably a slurry reactor, more preferably a loop reactor;
b) withdrawing said first polymerization mixture from the first polymerization reactor and optionally carrying out steps c1) through c3) prior to step d)
c1) transferring the first polymerization mixture into a second polymerization reactor, preferably a gas phase reactor;
c2) polymerizing propylene, ethylene and 1-butene comonomer units in said second polymerization reactor in the presence of said single-site catalyst to produce a second polymerization mixture comprising the first random terpolymer fraction (PP1), the second random terpolymer fraction (PP2) and the single-site catalyst;
c3) withdrawing said second polymerization mixture from said second polymerization reactor; and
d) compounding the first polymerization mixture if steps c1) to c3) are not present, or the second polymerization mixture if steps c1) to c3) are present, with the one or more alpha nucleating agents (NU), optionally with a visbreaking agent (V) and optionally with the addition of further additives to form the alpha-nucleated monophasic propylene terpolymer composition (PC).

In a final aspect, the present invention is directed to an article, more preferably a film, comprising the alpha-nucleated monophasic propylene terpolymer composition (PC) according to either of the first two aspects in an amount of at least 75 wt.-%, more preferably at least 90 wt.-%, most preferably at least 95 wt.-%.

### Definitions

Unless defined otherwise, all technical and scientific terms used herein have the same meaning as commonly understood by one of ordinary skill in the art to which the invention pertains. Although, any methods and materials similar or equivalent to those described herein can be used in practice for testing of the present invention, the preferred materials and methods are described herein. In describing and claiming the present invention, the following terminology will be used in accordance with the definitions set out below.

Unless clearly indicated otherwise, use of the terms “a”, “an”, and the like refers to one or more.

In the following amounts are given in % by weight (wt.-%) unless it is stated otherwise.

A propylene homopolymer is a polymer that essentially consists of propylene monomer units. Due to impurities especially during commercial polymerization processes, a propylene homopolymer can comprise up to 0.1 mol % comonomer units, preferably up to 0.05 mol % comonomer units and most preferably up to 0.01 mol % comonomer units.

A propylene random copolymer is a copolymer of propylene monomer units and comonomer units, preferably selected from ethylene and C₄-C₈ alpha-olefins, in which the comonomer units are distributed randomly over the polymeric chain. The propylene random copolymer can comprise comonomer units from one or more comonomers different in their amounts of carbon atoms.

A propylene random terpolymer is a random copolymer, as described above, which comprises of propylene and two different comonomer units, typically propylene, ethylene and a C₄-C₈ alpha-olefin.

Pseudo terpolymers being made from mixtures of two copolymers (e.g. a mixture of a propylene/ethylene copolymer with a propylene/1-butene copolymer) do not subsume under the term “terpolymer” according to the present invention. Pseudo terpolymers can be recognized by coupled TREF-IR, coupled TREF-NMR or similar methods.

Typical for monophasic propylene homopolymers and monophasic propylene random copolymers (including monophasic propylene random terpolymers) is the presence of only one glass transition temperature.

Bimodal polymers are polymers having a bimodal distribution of one or more properties. Bimodal random propylene terpolymers may typically be bimodal with respect to comonomer content or bimodal with respect to molecular weight (as seen through the melt flow rates of the first fraction and the final composition).

Particulate nucleating agents are a family of nucleating agents having very high melting temperature. During the processing of the polymer, they remain in the solid state and do not melt and dissolve, instead being dispersed into the polymer melt. This is different from soluble nucleating agents, which dissolve into the polymer melt during processing.

### DETAILED DESCRIPTION

Alpha nucleatied monophasic propylene terpolymer composition (PC)

In a first aspect, the present invention is directed to an alpha-nucleated monophasic propylene terpolymer composition (PC), comprising:
a) a propylene/ethylene/1-butene random terpolymer (PP), having:
   i) an ethylene content (C2), as determined by quantitative ¹³C-NMR spectroscopy, in the range from 0.75 to 4.0 mol-%;
   ii) a 1-butene content (C4), as determined by quantitative ¹³C-NMR spectroscopy, in the range from 2.0 to 7.5 mol-%; and
   iii) a content of 2,1-regiodefects, as determined by quantitative ¹³C-NMR spectroscopy analysis, in the range from 0.1 to 1.5 mol-%, and
b) one or more alpha nucleating agents (NU), wherein at least one of the one or more alpha nucleating agents is a particulate alpha nucleating agent,
   wherein the total amounts of the propylene/ethylene/1-butene random terpolymer (PP) and the one or more alpha nucleating agents (NU) add up to at least 95 wt.-% of the total weight of the alpha-nucleated monophasic propylene terpolymer composition (PC),
   wherein the alpha-nucleated monophasic propylene terpolymer composition (PC) has each of the following properties:
i) a melt flow rate (MFR₂), determined according to ISO 1133 at 230° C. at a load of 2.16 kg, in the range from 1.0 to 35 g/10 min;
ii) a melting temperature, determined according to DSC analysis, in the range from 125 to 140° C.; and
iii) a crystallization temperature, determined according to DSC analysis, in the range from 95 to 115° C.

In said first aspect, the alpha-nucleated monophasic propylene terpolymer composition preferably has:
a) a 1.5 N Hot Tack sealing process window, measured on a 50 μm blown film sample, in the range from 15 to 25° C., or
b) a 1.5 N Hot Tack sealing process window, measured on a 50 μm cast film sample, in the range from 20 to 30° C.

In a second aspect, the present invention is directed to an alpha-nucleated monophasic propylene terpolymer composition (PC) having:
i) an ethylene content (C2), as determined by quantitative ¹³C-NMR spectroscopy, in the range from 0.75 to 4.0 mol-%;
ii) a 1-butene content (C4), as determined by quantitative ¹³C-NMR spectroscopy, in the range from 2.0 to 7.5 mol-%;
iii) a melt flow rate (MFR₂), determined according to ISO 1133 at 230° C. at a load of 2.16 kg, in the range from 1.0 to 35 g/10 min;
iv) a melting temperature, determined according to DSC analysis, in the range from 125 to 140° C.; and
v) a crystallization temperature, determined according to DSC analysis, in the range from 95 to 115° C.,
   wherein the alpha-nucleated monophasic propylene terpolymer composition (PC) furthermore has:
a) a 1.5 N Hot Tack sealing process window, measured on a 50 μm blown film sample, in the range from 15 to 25° C., or
b) a 1.5 N Hot Tack sealing process window, measured on a 50 μm cast film sample, in the range from 20 to 30° C.

In said second aspect, the alpha-nucleated monophasic propylene terpolymer composition (PC) preferably comprises:
a) a propylene/ethylene/1-butene random terpolymer (PP), having:
   i) ethylene content (C2), as determined by quantitative ¹³C-NMR spectroscopy, in the range from 0.75 to 4.0 mol-%;
   ii) a 1-butene content (C4), as determined by quantitative ¹³C-NMR spectroscopy, in the range from 2.0 to 7.5 mol-%; and
   iii) a content of 2,1-regiodefects, as determined by quantitative ¹³C-NMR spectroscopy analysis, in the range from 0.1 to 1.5 mol-%, and
b) one or more alpha nucleating agents (NU), wherein at least one of the one or more alpha nucleating agents is a particulate alpha nucleating agent,
   wherein the total amounts of the propylene/ethylene/1-butene random terpolymer (PP) and the one or more alpha nucleating agents (NU) add up to at least 95 wt.-% of the total weight of the alpha-nucleated monophasic propylene terpolymer composition (PC).

All further fallbacks and preferable embodiments apply equally to the alpha-nucleated monophasic propylene terpolymer composition (PC) of the first and second aspects, unless explicitly stated otherwise.

The alpha-nucleated monophasic propylene terpolymer composition (PC) has a melt flow rate (MFR₂), determined according to ISO 1133 at 230° C. at a load of 2.16 kg, in the range from 1.0 to 35 g/10 min, more preferably in the range from 3.0 to 33 g/10 min, most preferably in the range from 5.0 to 32 g/10 min.

The alpha-nucleated monophasic propylene terpolymer composition (PC) according to the present invention may either be visbroken or non-visbroken.

As is well understood by the skilled person, the process of visbreaking involves treating a precursor polymer with a visbreaking agent, i.e. a free-radical generator. The polymeric chains of the precursor polymer may undergo beta-scission process and/or crosslinking, although in the absence of specific crosslinking agents, typically small molecules with multiple positions of unsaturation (e.g. bis- or tris-olefins), beta-scission processes tend to dominate. The effect of visbreaking is that the high molecular weight fractions of the molecular weight distribution are cleaved to form lower molecular weight polymer chains. Since these high molecular weight fractions contribute disproportionally to the MFR₂ of the overall polymer, visbreaking serves to increase the MFR₂ of polymers.

As would be clear to the person skilled in the art, it is possible to determine whether a polymer has been visbroken or not, not only by evaluating the shape of the resultant molecular weight distribution curve, but also by the presence of decomposition products of the visbreaking agent, e.g. peroxide decomposition products.

Some other properties of the polymer may be slightly modified as a result of the visbreaking procedure, for example a small change in XCS content may be expected; however, the predominant effect is on the rheological/molecular weight parameters, such as melt flow rate. Properties such as comonomer content should not, in principle, be affected by the visbreaking process; however, minor discrepancies may be observed as a result of measurement errors (e.g. the presence of cross-linked species may complicate the calculations used to determine comonomer content). Such discrepancies are near negligible in practice.

In a first embodiment, the alpha-nucleated monophasic propylene terpolymer composition (PC) according to the present invention has not been visbroken.

In this non-visbroken embodiment, the alpha-nucleated monophasic propylene terpolymer composition (PC) has a melt flow rate (MFR₂), determined according to ISO 1133 at 230° C. at a load of 2.16 kg, in the range from 1.0 to 10.0 g/10 min, more preferably in the range from 3.0 to 9.0 g/10 min, most preferably in the range from 5.0 to 8.0 g/10 min.

In a second embodiment, the propylene/ethylene/1-butene random terpolymer (PP) has been formed by visbreaking a precursor propylene/ethylene/1-butene random terpolymer (PP′) using a visbreaking agent, more preferably using a peroxide radical generator.

In this visbroken embodiment, the alpha-nucleated monophasic propylene terpolymer composition (PC) has a melt flow rate (MFR₂), determined according to ISO 1133 at 230° C. at a load of 2.16 kg, in the range from 20 to 35 g/10 min, more preferably in the range from 25 to 33 g/10 min, most preferably in the range from 28 to 32 g/10 min.

The precursor propylene/ethylene/1-butene random terpolymer (PP′) preferably has a melt flow rate (MFR₂), determined according to ISO 1133 at 230° C. at a load of 2.16 kg, in the range from 1.0 to 10.0 g/10 min, more preferably in the range from 3.0 to 9.0 g/10 min, most preferably in the range from 5.0 to 8.0 g/10 min.

In all other aspects (other than melt flow rate), the fallback ranges and preferred embodiments given above and below for the propylene/ethylene/1-butene random terpolymer (PP) apply mutatis mutandis to the precursor propylene/ethylene/1-butene random terpolymer (PP′).

The alpha-nucleated monophasic propylene terpolymer composition (PC) of the first aspect preferably has an ethylene content (C2), as determined by quantitative ¹³C-NMR spectroscopy, in the range from 0.75 to 4.0 mol-%, more preferably in the range from 1.2 to 3.0 mol-%, most preferably in the range from 1.5 to 2.5 mol.-%.

The alpha-nucleated monophasic propylene terpolymer composition (PC) of the first aspect preferably has a 1-butene content (C4), as determined by quantitative ¹³C-NMR spectroscopy, in the range from 2.0 to 7.5 mol-%, more preferably in the range from 2.5 to 6.0 mol-%, most preferably in the range from 3.0 to 5.0 mol.-%.

The alpha-nucleated monophasic propylene terpolymer composition (PC) of the second aspect has an ethylene content (C2), as determined by quantitative ¹³C-NMR spectroscopy, in the range from 0.75 to 4.0 mol-%, more preferably in the range from 1.2 to 3.0 mol-%, most preferably in the range from 1.5 to 2.5 mol.-%.

The alpha-nucleated monophasic propylene terpolymer composition (PC) of the second aspect has a 1-butene content (C4), as determined by quantitative ¹³C-NMR spectroscopy, in the range from 2.0 to 7.5 mol-%, more preferably in the range from 2.5 to 6.0 mol-%, most preferably in the range from 3.0 to 5.0 mol.-%.

The alpha-nucleated monophasic propylene terpolymer composition (PC) has a melting temperature, determined according to DSC analysis, in the range from 125 to 140° C., more preferably in the range from 130 to 139° C., most preferably in the range from 135 to 138° C.

It is preferred that this melting temperature has an associated enthalpy of fusion, determined according to DSC analysis, in the range from 50 to 80 J/g, more preferably in the range from 60 to 77 J/g, most preferably in the range from 70 to 75 J/g.

It is further preferred that the melting temperature is in the range from 1.0 to 6.0° C. higher than an analogous non-nucleated monophasic propylene terpolymer composition, more preferably in the range from 2.0 to 5.0° C. higher, most preferably in the range from 3.0 to 4.0° C. higher.

The alpha-nucleated monophasic propylene terpolymer composition (PC) has a crystallization temperature, determined according to DSC analysis, in the range from 95 to 115° C., more preferably in the range from 100 to 112° C., most preferably in the range from 105 to 110° C.

It is further preferred that the crystallization temperature is in the range from 5.0 to 15.0° C. higher than an analogous non-nucleated monophasic propylene terpolymer composition, more preferably in the range from 8.0 to 14.0° C. higher, most preferably in the range from 10.0 to 3.0° C. higher.

It is preferred that this crystallization temperature has an associated enthalpy of crystallization, determined according to DSC analysis, in the range from 50 to 80 J/g, more preferably in the range from 60 to 77 J/g, most preferably in the range from 70 to 75 J/g.

As the alpha-nucleated monophasic propylene terpolymer composition (PC) is not a heterophasic system comprising an elastomeric rubber layer, the alpha-nucleated propylene terpolymer composition (PC) preferably does not have a glass transition temperature below −30° C., more preferably does not have a glass transition temperature below −25° C., most preferably does not have a glass transition temperature below −20° C.

It is preferred that the alpha-nucleated monophasic propylene terpolymer composition (PC) has a clarity value, determined according to ASTM D1003 on a 50 μm cast film sample, in the range from 98.0 to 100%, more preferably in the range from 99.0 to 100%, most preferably in the range from 99.5 to 100%, and/or
a clarity value, determined according to ASTM D1003 on a 50 μm blown film sample, in the range from 98.0 to 100%, more preferably in the range from 99.0 to 100%, most preferably in the range from 99.5 to 100%.

It is preferred that the alpha-nucleated monophasic propylene terpolymer composition (PC) has a haze value, determined according to ASTM D1003 on a 50 μm cast film sample, in the range from 0.0 to 1.0%, more preferably in the range from 0.0 to 0.7%, most preferably in the range from 0.0 to 0.5%, and/or
a haze value, determined according to ASTM D1003 on a 50 μm blown film sample, in the range from 0.0 to 4.0%, more preferably in the range from 0.0 to 3.0%, most preferably in the range from 0.0 to 2.5%.

It is preferred that the alpha-nucleated monophasic propylene terpolymer composition (PC) has a sealing initiation temperature (SIT), determined on a 50 μm cast film sample, in the range from 100 to 120° C., more preferably in the range from 102 to 115° C., most preferably in the range from 103 to 110° C., and/or
a sealing initiation temperature (SIT), determined on a 50 μm blown film sample, in the range from 110 to 125° C., more preferably in the range from 112 to 120° C., most preferably in the range from 113 to 117° C.

It is preferred that the alpha-nucleated monophasic propylene terpolymer composition (PC) has a sealing end temperature (SET), determined on a 50 μm cast film sample, in the range from 115 to 130° C., more preferably in the range from 120 to 128° C., most preferably in the range from 123 to 127° C.

It is preferred that the alpha-nucleated monophasic propylene terpolymer composition (PC) has a difference between the sealing end temperature (SET) and the sealing initiation temperature (SIT), both determined on a 50 μm cast film sample, in the range from 10 to 25° C., more preferably in the range from 13 to 22° C., most preferably in the range from 15 to 20° C.

It is preferred that the difference between the melting temperature of the alpha-nucleated monophasic propylene terpolymer composition (PC), determined according to DSC analysis, and the sealing initiation temperature (SIT), determined on a 50 μm cast film sample, is in the range from 25 to 40° C., more preferably in the range from 28 to 37° C., most preferably in the range from 30 to 34° C., and/or
that the difference between the melting temperature of the alpha-nucleated monophasic propylene terpolymer composition (PC), determined according to DSC analysis, and the sealing initiation temperature (SIT), determined on a 50 μm blown film sample, is in the range from 15 to 30° C., more preferably in the range from 18 to 27° C., most preferably in the range from 20 to 24° C.

It is preferred that the alpha-nucleated monophasic propylene terpolymer composition (PC) has a maximum sealing force, determined on a 50 μm cast film sample in the range from 10 to 25 N, more preferably in the range from 13 to 22 N, most preferably in the range from 15 to 20 N, and/or
a maximum sealing force, determined on a 50 μm blown film sample in the range from 15 to 30 N, more preferably in the range from 18 to 27 N, most preferably in the range from 20 to 25 N.

It is preferred that the alpha-nucleated monophasic propylene terpolymer composition (PC) has a Hot Tack force, determined according to ASTM F1921-12-Method B on a 50 μm cast film sample, in the range from 2.0 to 5.0 N, more preferably in the range from 2.5 to 4.5 N, most preferably in the range from 3.0 to 4.0 N, and/or
a Hot Tack force, determined according to ASTM F1921-12-Method B on a 50 μm blown film sample, in the range from 2.0 to 5.0 N, more preferably in the range from 2.5 to 4.5 N, most preferably in the range from 3.0 to 4.0 N

It is preferred that the alpha-nucleated monophasic propylene terpolymer composition (PC) has a Hot Tack temperature determined on a 50 μm cast film sample, in the range from 95 to 115° C., more preferably in the range from 100 to 110° C., most preferably in the range from 104 to 106° C., and/or a Hot Tack temperature determined on a 50 μm blown film sample, in the range from 100 to 115° C., more preferably in the range from 105 to 113° C., most preferably in the range from 108 to 111° C.

It is preferred that the alpha-nucleated monophasic propylene terpolymer composition (PC) has a 1.5 N Hot Tack sealing process window, determined on a 50 μm cast film sample, in the range from 20 to 30° C., more preferably in the range from 22 to 28° C., most preferably in the range from 23 to 27° C., and/or
a 1.5 N Hot Tack sealing process window, determined on a 50 μm blown film sample, in the range from 15 to 25° C., more preferably in the range from 17 to 23° C., most preferably in the range from 18 to 22° C.

It is preferred that the alpha-nucleated monophasic propylene terpolymer composition (PC) has a tensile storage modulus (E′), determined on a 50 μm cast film sample, in the range from 600 to 1500 MPa, more preferably in the range from 700 to 1200 MPa, most preferably in the range from 750 to 1000 MPa, and/or
a tensile storage modulus (E′), determined on a 50 μm blown film sample, in the range from 1000 to 1700 MPa, more preferably in the range from 1200 to 1600 MPa, most preferably in the range from 1300 to 1500 MPa.

It is preferred that the alpha-nucleated monophasic propylene terpolymer composition (PC) has a dart drop impact strength, measured according to ASTM D1709-A on a 50 μm cast film sample, in the range from 350 to 550 g, more preferably in the range from 380 to 500 g, most preferably in the range from 410 to 450 g, and/or
a dart drop impact strength, measured according to ASTM D1709-A on a 50 μm blown film sample, in the range from 40 to 60 g, more preferably in the range from 45 to 57 g, most preferably in the range from 50 to 55 g.

It is preferred that the alpha-nucleated monophasic propylene terpolymer composition (PC) has a Gloss at 60°, measured according to ISO 2813 in the machine direction on a 50 μm blown film sample, in the range from 120 to 170 GU, more preferably in the range from 130 to 160 GU, most preferably in the range from 135 to 150 GU.

It is preferred that the alpha-nucleated monophasic propylene terpolymer composition (PC) has a Gloss at 60°, measured according to ISO 2813 in the transverse direction on a 50 μm blown film sample, in the range from 120 to 170 GU, more preferably in the range from 130 to 160 GU, most preferably in the range from 135 to 150 GU.

In the first aspect, the alpha-nucleated monophasic propylene terpolymer composition (PC) comprises the propylene/ethylene/1-butene random terpolymer (PP) and one or more alpha nucleating agents, wherein at least one of the one or more alpha nucleating agents is a particulate alpha nucleating agent.

In the second aspect, the alpha-nucleated monophasic propylene terpolymer composition (PC) preferably comprises the propylene/ethylene/1-butene random terpolymer (PP) and one or more alpha nucleating agents, wherein at least one of the one or more alpha nucleating agents is a particulate alpha nucleating agent.

In both aspects, it is preferred that the alpha-nucleated monophasic propylene terpolymer composition (PC) comprises the propylene/ethylene/1-butene random terpolymer (PP) in an amount in the range from 90.0 wt.-% to 99.99 wt.-% more preferably in the range from 95.0 to 99.9 wt.-%, most preferably in the range from 99.0 to 99.8 wt.-%.

In both aspects, it is preferred that the alpha-nucleated monophasic propylene terpolymer composition (PC) comprises the one or more alpha nucleating agents (NU) in a total amount in the range from 0.01 wt.-% to 1.00 wt.-% more preferably in the range from 0.05 to 0.50 wt.-%, most preferably in the range from 0.08 to 0.30 wt.-%.

In addition to the propylene/ethylene/1-butene random terpolymer (PP) and the one or more alpha nucleating agents (NU), the alpha-nucleated monophasic propylene terpolymer composition (PC) may comprise further additives known in the art; however, this remaining part shall be not more than 5.0 wt.-%, like not more than 3.0 wt.-% within the alpha-nucleated monophasic propylene terpolymer composition (PC). For instance, the alpha-nucleated monophasic propylene terpolymer composition (PC) may comprise additionally small amounts of additives (A) selected from the group consisting of antioxidants, stabilizers, fillers, colorants, nucleating agents and antistatic agents. In general, they may be incorporated during the compounding of the alpha-nucleated monophasic propylene terpolymer composition (PC).

It is preferred that the alpha-nucleated monophasic propylene terpolymer composition (PC) is free of beta-nucleating agents.

In case the alpha-nucleated monophasic propylene terpolymer composition (PC) comprises an α-nucleating agent other than the particulate alpha nucleating agent, it is preferred that any additional α-nucleating agents are preferably selected from the group consisting of
(i) salts of monocarboxylic acids and polycarboxylic acids, e.g. sodium benzoate or aluminum tert-butylbenzoate, and
(ii) salts of diesters of phosphoric acid, e.g. sodium 2,2′-methylenebis (4,6,-di-tert-butylphenyl) phosphate or aluminium-hydroxy-bis[2,2′-methylene-bis(4,6-di-t-butylphenyl)phosphate], and
(iii) vinylcycloalkane polymer and vinylalkane polymer (as discussed in more detail below), and
(iv) mixtures thereof.

Such additives are generally commercially available and are described, for example, in “Plastic Additives Handbook”, pages 871 to 873, 5th edition, 2001 of Hans Zweifel.

It is understood that the content of additives (A), given with respect to the total weight of the alpha-nucleated monophasic propylene terpolymer composition (PC), includes any carrier polymers used to introduce the additives to said alpha-nucleated monophasic propylene terpolymer composition (PC), i.e. masterbatch carrier polymers. An example of such a carrier polymer would be a polypropylene homopolymer in the form of powder.

In one particular embodiment, the alpha-nucleated monophasic propylene terpolymer composition (PC) consists of the propylene/ethylene/1-butene random terpolymer (PP), the one or more alpha nucleating agents (NU), and optionally additives (A).

Propylene/ethylene/1-butene random terpolymer (PP)

The propylene/ethylene/1-butene random terpolymer (PP) preferably has a melt flow rate (MFR₂), determined according to ISO 1133 at 230° C. at a load of 2.16 kg, in the range from 1.0 to 10.0 g/10 min, more preferably in the range from 3.0 to 9.0 g/10 min, most preferably in the range from 5.0 to 8.0 g/10 min.

The propylene/ethylene/1-butene random terpolymer (PP) has an ethylene content (C2), as determined by quantitative ¹³C-NMR spectroscopy, in the range from 0.75 to 4.0 mol-%, more preferably in the range from 1.2 to 3.0 mol-%, most preferably in the range from 1.5 to 2.5 mol-%.

The propylene/ethylene/1-butene random terpolymer (PP) has a 1-butene content (C4), as determined by quantitative ¹³C-NMR spectroscopy, in the range from 2.0 to 7.5 mol-%, more preferably in the range from 2.5 to 6.0 mol-%, most preferably in the range from 3.0 to 5.0 mol.-%.

The propylene/ethylene/1-butene random terpolymer (PP) has a content of 2,1-regiodefects, as determined by quantitative ¹³C-NMR spectroscopy analysis, in the range from 0.10 to 1.50 mol %, more preferably in the range from 0.15 to 1.00 mol %, most preferably in the range from 0.20 to 0.80 mol %.

The presence of 2,1-regiodefects in the propylene/ethylene/1-butene random terpolymer (PP) is generally indicative that the propylene/ethylene/1-butene random terpolymer (PP) has been polymerized in the presence of a single site catalyst (SSC).

It is therefore preferred that the propylene/ethylene/1-butene random terpolymer (PP) has been polymerized in the presence of a single site catalyst (SSC), more preferably a metallocene catalyst. It is particularly preferred that the propylene/ethylene/1-butene random terpolymer (PP) has been polymerized according to the process of the third embodiment, described below.

The content of 2,1-regiodefects may be dependent on the amount of comonomer, with higher amounts of comonomers often associated with lower content of 2,1-regiodefects.

The content of 2,1-regiodefects may also be dependent on the polymerization temperature, with higher temperatures often associated with lower content of 2,1-regiodefects.

The propylene/ethylene/1-butene random terpolymer (PP) preferably has a xylene cold soluble content (XCS), as determined according to ISO 16152, in the range from 1.00 to 4.00 wt.-%, more preferably in the range from 1.5 to 3.5 wt.-%, most preferably in the range from 1.80 to 3.00 wt.-%.

The propylene/ethylene/1-butene random terpolymer (PP) preferably has a melting temperature, determined according to DSC analysis, in the range from 125 to 140° C., more preferably in the range from 128 to 137° C., most preferably in the range from 131 to 135° C.

It is preferred that this melting temperature has an associated enthalpy of fusion, determined according to DSC analysis, in the range from 50 to 80 J/g, more preferably in the range from 60 to 77 J/g, most preferably in the range from 68 to 73 J/g.

The propylene/ethylene/1-butene random terpolymer (PP) preferably has a crystallization temperature, determined according to DSC analysis, in the range from 85 to 100° C., more preferably in the range from 90 to 98° C., most preferably in the range from 94 to 97° C.

It is further preferred that the crystallization temperature is in the range from 5.0 to 15.0° C. higher than an analogous non-nucleated monophasic propylene terpolymer composition, more preferably in the range from 8.0 to 14.0° C. higher, most preferably in the range from 10.0 to 3.0° C. higher.

The propylene/ethylene/1-butene random terpolymer (PP) may be either unimodal or multimodal, for example bimodal.

As would be well understood by the person skilled in the art, the modality of a polymer composition my be defined with regard to many properties, with the most common properties being multimodality, e.g. bimodality, with respect to melt flow rate or comonomer content.

It is particularly preferred that the propylene/ethylene/1-butene random terpolymer (PP) is bimodal, either with respect to melt flow rate, with respect to ethylene content, or with respect to 1-butene content.

Bimodal polymers may either be produced by blending two unimodal polymers or by utilizing a multi-reactor polymerization process, whereby a first polymer fraction is polymerized in a first polymerization reactor, with said first polymer fraction being transferred into a second polymerization reactor, wherein a second polymer fraction, differing from the first polymer fraction in one or more properties, is polymerized under different conditions, thereby forming a bimodal polymer.

It is thus preferred that the propylene/ethylene/1-butene random terpolymer (PP) comprises a first random terpolymer fraction (PP1) and a second terpolymer fraction (PP2) as described below.

It is particularly preferred that the propylene/ethylene/1-butene random terpolymer (PP) comprises:
a) 40 to 80 wt.-%, relative to the total weight of the propylene/ethylene/1-butene random terpolymer (PP), of a first random terpolymer fraction (PP1), having an ethylene content (C2), as determined by quantitative ¹³C-NMR spectroscopy, in the range from 0.75 to 4.0 mol-%, and a 1-butene content (C4), as determined by quantitative ¹³C-NMR spectroscopy, in the range from 1.0 to 5.0 mol-%; and
b) 20 to 60 wt.-%, relative to the total weight of the propylene/ethylene/1-butene random terpolymer (PP), of a second random terpolymer fraction (PP2), having an ethylene content (C2), as determined by quantitative ¹³C-NMR spectroscopy, in the range from 0.75 to 4.0 mol-%, and a 1-butene content (C4), as determined by quantitative ¹³C-NMR spectroscopy, in the range from 3.0 to 10.0 mol-%,
   wherein the first random terpolymer fraction (PP1) and the second random terpolymer fraction (PP2) combined make up at least 95 wt.-% of the total weight of the propylene/ethylene/1-butene random terpolymer (PP).
   First random terpolymer fraction (PP1)

The first random terpolymer fraction (PP1) is a terpolymer of propylene, ethylene and 1-butene.

The first random terpolymer fraction (PP1) preferably has an ethylene content (C2), as determined by quantitative ¹³C-NMR spectroscopy, in the range from 0.75 to 4.0 mol-%, more preferably in the range from 1.5 to 3.5 mol-%, most preferably in the range from 2.0 to 3.0 mol.-%.

The first random terpolymer fraction (PP1) preferably has a 1-butene content (C4), as determined by quantitative ¹³C-NMR spectroscopy, in the range from 1.0 to 5.0 mol-%, more preferably in the range from 1.5 to 4.0 mol-%, most preferably in the range from 2.0 to 3.0 mol.-%.

The first random terpolymer fraction (PP1) preferably has a melt flow rate (MFR₂), determined according to ISO 1133 at 230° C. at a load of 2.16 kg, in the range from 1.0 to 10 g/10 min, more preferably in the range from 3.0 to 8.0 g/10 min, most preferably in the range from 5.0 to 7.0 g/10 min.

Second random terpolymer fraction (PP2)

The second random terpolymer fraction (PP2) is a terpolymer of propylene, ethylene and 1-butene.

The second random terpolymer fraction (PP2) has an ethylene content (C2), as determined by quantitative ¹³C-NMR spectroscopy, in the range from 0.75 to 4.0 mol-%, more preferably in the range from 1.5 to 3.5 mol-%, most preferably in the range from 2.0 to 3.0 mol.-%.

The second random terpolymer fraction (PP2) has a 1-butene content (C4), as determined by quantitative ¹³C-NMR spectroscopy, in the range from 3.0 to 10.0 mol-%, more preferably in the range from 4.0 to 8.0 mol-%, most preferably in the range from 4.5 to 6.0 mol.-%.

The second random terpolymer fraction (PP2) preferably has a melt flow rate (MFR₂), determined according to ISO 1133 at 230° C. at a load of 2.16 kg, in the range from 1.0 to 20.0 g/10 min, more preferably in the range from 4.0 to 17.0 g/10 min, most preferably in the range from 7.0 to 14.0 g/10 min.

### Bimodal Propylene/Ethylene/1-Butene Random Terpolymer

The bimodal propylene/ethylene/1-butene random terpolymer comprises 40 to 80 wt.-%, relative to the total weight of the bimodal propylene/ethylene/1-butene random terpolymer, of a first random terpolymer fraction (PP1) and 20 to 60 wt.-%, relative to the total weight of the bimodal propylene/ethylene/1-butene random terpolymer, of a second random terpolymer fraction (PP2).

More preferably, the bimodal propylene/ethylene/1-butene random terpolymer comprises 50 to 75 wt.-%, relative to the total weight of the bimodal propylene/ethylene/1-butene random terpolymer composition, of the first random terpolymer fraction (PP1) and 25 to 50 wt.-%, relative to the total weight of the bimodal propylene/ethylene/1-butene random terpolymer, of the second random terpolymer fraction (PP2).

It is particularly preferred that the bimodal propylene/ethylene/1-butene random terpolymer comprises 55 to 70 wt.-%, relative to the total weight of the bimodal propylene/ethylene/1-butene random terpolymer, of the first random terpolymer fraction (PP1) and 30 to 45 wt.-%, relative to the total weight of the bimodal propylene/ethylene/1-butene random terpolymer, of the second random terpolymer fraction (PP2).

The first random terpolymer fraction (PP1) and the second random terpolymer fraction (PP2) combined make up at least 95 wt.-% of the total weight of the bimodal propylene/ethylene/1-butene random terpolymer.

As mentioned previously, the bimodal propylene/ethylene/1-butene random terpolymer may be bimodal with respect to molecular weight (as indicated by melt flow rate values). As such, it is preferred that the ratio of the melt flow rate (MFR₂) of the bimodal propylene/ethylene/1-butene random terpolymer (PP) to the melt flow rate (MFR₂) of the first random terpolymer fraction (PP1), both determined according to ISO 1133 at 230° C. at a load of 2.16 kg and expressed in g/10 min, ([MFR(PP)]/[MFR(PP1)]) is in the range from 0.50 to 1.50, more preferably in the range from 0.80 to 1.30, most preferably in the range from 1.00 to 1.20.

The bimodal propylene/ethylene/1-butene random terpolymer may additionally or alternatively be bimodal with respect to comonomer content, i.e. either bimodal with respect to ethylene content, 1-butene content, or both. Consequently, the ethylene content of the first random terpolymer fraction, C2(PP1), may differ from ethylene content of the second random terpolymer fraction, C2(PP2), and/or the 1-butene content of the first random terpolymer fraction, C4(PP1), may differ from the 1-butene content of the second random terpolymer fraction, C4(PP2).

As mentioned previously, the bimodal propylene/ethylene/1-butene random terpolymer may be bimodal with respect to ethylene content. As such, it is preferred that the ratio of the ethylene content of the bimodal propylene/ethylene/1-butene random terpolymer (PP) to the ethylene content of the first random terpolymer fraction (PP1), both determined by quantitative ¹³C-NMR spectroscopy and expressed in mol-%, ([C2(PP)]/[C2(PP1)]) is in the range from 0.70 to 1.30, more preferably in the range from 0.80 to 1.20, most preferably in the range from 0.90 to 1.10.

As mentioned previously, the bimodal propylene/ethylene/1-butene random terpolymer may be bimodal with respect to 1-butene content. As such, it is preferred that ratio of the 1-butene content of the bimodal propylene/ethylene/1-butene random terpolymer to the 1-butene content of the first random terpolymer fraction (PP1), both determined by quantitative ¹³C-NMR spectroscopy and expressed in mol-%, ([C4(PP)]/[C4(PP1)]) is in the range from 1.00 to 2.00, more preferably in the range from 1.20 to 1.70, most preferably in the range from 1.30 to 1.50.

### One or More Alpha Nucleating Agents (NU)

At least one of the one or more alpha nucleating agents is a particulate alpha nucleating agent.

Preferably, at least one of the one or more alpha nucleating agents (NU) is a particulate alpha nucleating agent that comprises a compound having a phosphate moiety.

Preferably, at least one of the one or more alpha nucleating agents (NU) is a particulate alpha nucleating agent that comprises a compound having the structure [(Ar¹O)(Ar²O)(O═)P—O]ₙX, wherein
Ar¹ and Ar² are each independently selected from phenyl groups substituted by one or more C₁ to C₆ linear or branched alkyl groups, wherein Ar¹ and Ar² may also be linked by a direct single bond, an O, or a C₁ to C₆ alkylene group
n is either 1 or 2, wherein if n=1, then X is selected from the group consisting of Li, Na, K, and Al(OH)₂, more preferably from the group consisting of Li, Na, and K, and if n=2, then X is selected from the group consisting of Mg, Ca, and Al(OH), more preferably from the group consisting of Mg and Ca.

More preferably, at least one of the one or more alpha nucleating agents (NU) is a particulate alpha nucleating agent that comprises a compound selected from the group consisting of sodium di(4-tert-butylphenyl)phosphate, sodium 2,2′-methylene-bis-(4,6-di-tert.butylphenyl) phosphate, lithium 2,2′-methylene-bis-(4,6-di-tert.butylphenyl)phosphate, and aluminium hydroxybis[2,2′-methylene-bis(4,6-di-tert-butylphenyl)phosphate], yet more preferably from the group consisting of sodium di(4-tert-butylphenyl)phosphate, sodium 2,2′-methylene-bis-(4,6-di-tert.butylphenyl)phosphate, lithium 2,2′-methylene-bis-(4,6-di-tert.butylphenyl) phosphate.

Most preferably, at least one of the one or more alpha nucleating agents (NU) comprises lithium 2,2′-methylene-bis-(4,6-di-tert.butylphenyl) phosphate.

As would be understood by the person skilled in the art, such particulate alpha nucleating agents may be present either as a single compound or as a particulate blend. One such particulate blend that contains lithium 2,2′-methylene-bis-(4,6-di-tert.butylphenyl) phosphate as the major component is ADK STAB NA-71, commercially available from Adeka Corp.

In an alternative embodiment, at least one of the one or more alpha nucleating agents (NU) is a particulate alpha nucleating agent that comprises a dicarboxylic acid derivative.

It is preferred that at least one of the one or more alpha nucleating agents (NU) is a particulate alpha nucleating agent that comprises a compound having a structure according to formula (I)

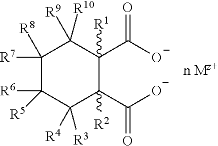

wherein each of R¹, R², R³, R⁴, R⁵, R⁶, R⁷, R⁸, R⁹ and R¹⁰ is independently selected from hydrogen and a C₁ to C₁₀ hydrocarbyl group;
whereby two of R³ to R¹⁰ located on adjacent carbon atoms may be fused to form a cyclic hydrocarbyl structure;
whereby two of R³ to R¹⁰ located on non-adjacent carbon atoms may be fused to form a bicyclic hydrocarbyl structure;
M is selected from the groups consisting of sodium, potassium, calcium, strontium, lithium, zinc, magnesium and monobasic aluminium;
n is 1 or 2;
z is 1 or 2;
the sum of n+z is 3.

More preferably, each of R¹, R², R³, R⁴, R⁵, R⁶, R⁷, R⁸, R⁹ and R¹⁰ is independently selected from hydrogen and a C₁ to C₄ alkyl group, even more preferably from hydrogen, methyl or ethyl. In one particularly preferred embodiment, each of R¹, R², R³, R⁴, R⁵, R⁶, R⁷, R⁸, R⁹ and R¹⁰ is hydrogen.

M is preferably sodium or calcium.

It is particularly preferred that at least one of the one or more alpha nucleating agents (NU) is a particulate alpha nucleating agent comprising a compound selected from bicyclo (2.2.1) heptane-2,3-dicarboxylic acid, disodium salt and calcium 1,2-cyclohexane dicarboxylate, most preferably calcium (1R,2S)-cyclohexane dicarboxylate.

As would be understood by the person skilled in the art, such particulate alpha nucleating agents may be present either as a single compound or as a particulate blend. One such particulate blend that contains calcium (1R,2S)-cyclohexane dicarboxylate as the major component is Hyperform HPN-20E, commercially available from Milliken Chemical.

### Process

The present invention is further directed to a process for producing the alpha-nucleated monophasic propylene terpolymer composition (PC) according to either of the first two aspects, comprising the steps of:
a) polymerizing propylene, ethylene and 1-butene comonomer units in a first polymerization reactor in the presence of a single-site catalyst to produce a first polymerization mixture comprising the first random terpolymer fraction (PP1) and the single-site catalyst, wherein the first polymerization reactor is preferably a slurry reactor, more preferably a loop reactor;
b) withdrawing said first polymerization mixture from the first polymerization reactor and optionally carrying out steps c1) through c3) prior to step d)
c1) transferring the first polymerization mixture into a second polymerization reactor, preferably a gas phase reactor;
c2) polymerizing propylene, ethylene and 1-butene comonomer units in said second polymerization reactor in the presence of said single-site catalyst to produce a second polymerization mixture comprising the first random terpolymer fraction (PP1), the second random terpolymer fraction (PP2) and the single-site catalyst;
c3) withdrawing said second polymerization mixture from said second polymerization reactor; and
d) compounding the first polymerization mixture if steps c1) to c3) are not present, or the second polymerization mixture if steps c1) to c3) are present, with the one or more alpha nucleating agents (NU), optionally with a visbreaking agent (V) and optionally with the addition of further additives to form the alpha-nucleated monophasic propylene terpolymer composition (PC).

As discussed above, the propylene/ethylene/1-butene random terpolymer (PP) may be either unimodal or bimodal. If the propylene/ethylene/1-butene random terpolymer (PP) is unimodal, then steps c1) to c3) are not present. If the propylene/ethylene/1-butene random terpolymer (PP) is bimodal, then steps c1) to c3) are present.

It is preferred that the operating temperature in the first polymerization reactor (R1) is in the range from 62 to 85° C., more preferably in the range from 65 to 82° C., still more preferably in the range from 67 to 80° C.

Alternatively or additionally to the previous paragraph it is preferred that the operating temperature in the second polymerization reactor (R²) is in the range from 75 to 95° C., more preferably in the range from 78 to 92° C.

Typically, the pressure in the first polymerization reactor (R¹), preferably in the loop reactor (LR), is in the range from 20 to 80 bar, preferably 30 to 70 bar, like 35 to 65 bar, whereas the pressure in the second polymerization reactor (R²), i.e. in the gas phase reactor (GPR), is in the range from 5 to 50 bar, preferably 15 to 40 bar.

Preferably hydrogen is added in each polymerization reactor in order to control the molecular weight, i.e. the melt flow rate MFR₂.

The preparation of the propylene random terpolymer can comprise in addition to the (main) polymerization of the propylene random terpolymer in the at two polymerization reactors (R1 and R2) prior thereto a pre-polymerization in a pre-polymerization reactor (PR) upstream to the first polymerization reactor (R1).

In the pre-polymerization reactor (PR) a polypropylene (Pre-PP) is produced. The pre-polymerization is conducted in the presence of the single site catalyst (SSC). According to this embodiment, the single site catalyst is introduced to the pre-polymerization step. However, this shall not exclude the option that at a later stage for instance further co-catalyst is added in the polymerization process, for instance in the first reactor (R1). In one embodiment, all components of the single site catalyst are only added in the pre-polymerization reactor (PR), if a pre-polymerization is applied.

The pre-polymerization reaction is typically conducted at a temperature of 0 to 60° C., preferably from 15 to 50° C., and more preferably from 20 to 45° C.

The pressure in the pre-polymerization reactor is not critical but must be sufficiently high to maintain the reaction mixture in liquid phase. Thus, the pressure may be from 20 to 100 bar, for example 30 to 70 bar.

In a preferred embodiment, the pre-polymerization is conducted as bulk slurry polymerization in liquid propylene, i.e. the liquid phase mainly comprises propylene, with optionally inert components dissolved therein. Furthermore, according to the present invention, an ethylene feed is employed during pre-polymerization as mentioned above.

It is possible to add other components also to the pre-polymerization stage. Thus, hydrogen may be added into the pre-polymerization stage to control the molecular weight of the polypropylene (Pre-PP) as is known in the art. Further, antistatic additive may be used to prevent the particles from adhering to each other or to the walls of the reactor.

The precise control of the pre-polymerization conditions and reaction parameters is within the skill of the art.

Due to the above defined process conditions in the pre-polymerization, preferably a mixture (MI) of the single site catalyst (SSC) and the polypropylene (Pre-PP) produced in the pre-polymerization reactor (PR) is obtained. Preferably the single site catalyst (SSC) is (finely) dispersed in the polypropylene (Pre-PP). In other words, the single site catalyst (SSC) particles introduced in the pre-polymerization reactor (PR) are split into smaller fragments that are evenly distributed within the growing polypropylene (Pre-PP). The sizes of the introduced single site catalyst (SSC) particles as well as of the obtained fragments are not of essential relevance for the instant invention and within the skilled knowledge.

As mentioned above, if a pre-polymerization is used, subsequent to said pre-polymerization, the mixture (MI) of the single site catalyst (SSC) and the polypropylene (Pre-PP) produced in the pre-polymerization reactor (PR) is transferred to the first reactor (R1). Typically the total amount of the polypropylene (Pre-PP) in the final bimodal propylene terpolymer (PP) is rather low and typically not more than 5.0 wt.-%, more preferably not more than 4.0 wt.-%, still more preferably in the range from 0.5 to 4.0 wt.-%, like in the range 1.0 of to 3.0 wt.-%.

In case that pre-polymerization is not used, propylene and the other ingredients such as the single site catalyst (SSC) are directly introduced into the first polymerization reactor (R1).

In one embodiment, the present invention is directed to an alpha-nucleated monophasic propylene terpolymer composition (PC) as described above that is obtainable, more preferably obtained, through the process as described herein. All preferable embodiments and fall back positions given for the alpha-nucleated monophasic propylene terpolymer composition (PC) above and below apply mutatis mutandis to the alpha-nucleated monophasic propylene terpolymer composition (PC) of the present embodiment.

### Catalyst System

The single site catalyst according to the present invention may be any supported metallocene catalyst suitable for the production of isotactic polypropylene.

It is preferred that the single site catalyst (SSC) comprises a metallocene complex, a co-catalyst system comprising a boron-containing co-catalyst and/or aluminoxane co-catalyst, and a silica support.

In particular, it is preferred that the single site catalyst (SSC) comprises
(i) a metallocene complex of the general formula (II)

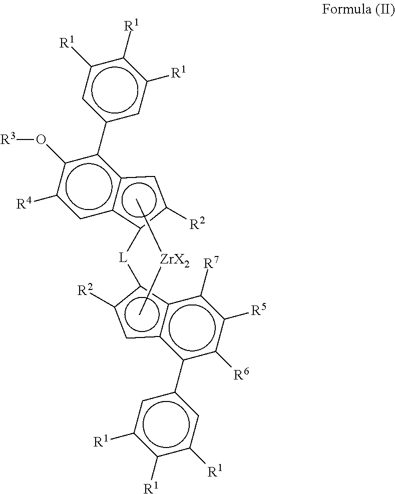

wherein each X independently is a sigma-donor ligand, L is a divalent bridge selected from —R′₂C—, —R′₂C—CR′₂—, —R′₂Si—, —R′₂Si—SiR′₂—, —R′₂Ge—, wherein each R′ is independently a hydrogen atom or a C1-C₂₀-hydrocarbyl group optionally containing one or more heteroatoms from groups 14-16 of the periodic table or fluorine atoms, or optionally two R′ groups taken together can form a ring,
each R¹ are independently the same or can be different and are hydrogen, a linear or branched C₁-C₆-alkyl group, a C₇₋₂₀-arylalkyl, C₇₋₂₀-alkylaryl group or C₆₋₂₀-aryl group or an OY group, wherein Y is a C₁₋₁₀-hydrocarbyl group, and optionally two adjacent R¹ groups can be part of a ring including the phenyl carbons to which they are bonded,
each R²independently are the same or can be different and are a CH₂—R⁸ group, with R⁸ being H or linear or branched C₁₋₆-alkyl group, C₃₋₈-cycloalkyl group, C₆₋₁₀-aryl group,
R³ is a linear or branched C₁-C₆-alkyl group, C₇₋₂₀-arylalkyl, C₇₋₂₀-alkylaryl group or C₆-C₂₀-aryl group,
R⁴ is a C(R⁹)₃ group, with R⁹ being a linear or branched C₁-C₆-alkyl group,
R⁵ is hydrogen or an aliphatic C₁-C₂₀-hydrocarbyl group optionally containing one or more heteroatoms from groups 14-16 of the periodic table;
R⁶ is hydrogen or an aliphatic C₁-C₂₀-hydrocarbyl group optionally containing one or more heteroatoms from groups 14-16 of the periodic table; or
R⁵ and R⁶ can be taken together to form a 5 membered saturated carbon ring which is optionally substituted by n groups R¹⁰, n being from 0 to 4;
each R¹⁰ is same or different and may be a C1-C₂₀-hydrocarbyl group, or a C₁-C₂₀-hydrocarbyl group optionally containing one or more heteroatoms belonging to groups 14-16 of the periodic table;
R⁷ is H or a linear or branched C1-C₆-alkyl group or an aryl or heteroaryl group having 6 to 20 carbon atoms optionally substituted by one to three groups R¹¹,
each R¹¹ are independently the same or can be different and are hydrogen, a linear or branched C₁-C₆-alkyl group, a C₇₋₂₀-arylalkyl, C₇₋₂₀-alkylaryl group or C₆₋₂₀-aryl group or an OY group, wherein Y is a C₁₋₁₀-hydrocarbyl group,
(ii) a co-catalyst system comprising a boron containing co-catalyst and/or an aluminoxane co-catalyst, and
(iii) a silica support.

The term “sigma-donor ligand” is well understood by the person skilled in the art, i.e. a group bound to the metal via a sigma bond. Thus the anionic ligands “X” can independently be halogen or be selected from the group consisting of R′, OR′, SiR′₃, OSiR′₃, OSO₂CF₃, OCOR′, SR′, NR′₂ or PR′₂ group wherein R′ is independently hydrogen, a linear or branched, cyclic or acyclic, C₁ to C₂₀ alkyl, C₂ to C₂₀ alkenyl, C₂ to C₂₀ alkynyl, C₃ to C₁₂ cycloalkyl, C₆ to C₂₀ aryl, C₇ to C₂₀ arylalkyl, C₇ to C₂₀ alkylaryl, C₈ to C₂₀ arylalkenyl, in which the R′ group can optionally contain one or more heteroatoms belonging to groups 14 to 16. In a preferred embodiment the anionic ligands “X” are identical and either halogen, like C1, or methyl or benzyl.

A preferred monovalent anionic ligand is halogen, in particular chlorine (C1).

Preferred complexes of the metallocene catalyst include:
rac-dimethylsilanediylbis[2-methyl-4-(3′,5′-dimethylphenyl)-5-methoxy-6-tert-butylinden-1-yl]zirconium dichloride,
rac-anti-dimethylsilanediyl[2-methyl-4-(4′-tert-butylphenyl)-inden-1-yl][2-methyl-4-(4′-tertbutylphenyl)-5-methoxy-6-tert-butylinden-1-yl]zirconium dichloride,
rac-anti-dimethylsilanediyl[2-methyl-4-(4′-tert-butylphenyl)-inden-1-yl][2-methyl-4-phenyl-5-methoxy-6-tert-butylinden-1-yl]zirconium dichloride,
rac-anti-dimethylsilanediyl[2-methyl-4-(3′,5′-tert-butylphenyl)-1,5,6,7-tetrahydro-sindacen-1-yl][2-methyl-4-(3′,5′-dimethyl-phenyl)-5-methoxy-6-tert-butylinden-1-yl]zirconium dichloride,
rac-anti-dimethylsilanediyl[2-methyl-4,8-bis-(4′-tert-butylphenyl)-1,5,6,7-tetrahydro-sindacen-1-yl][2-methyl-4-(3′,5′-dimethyl-phenyl)-5-methoxy-6-tert-butylinden-1-yl]zirconium dichloride,
rac-anti-dimethylsilanediyl[2-methyl-4,8-bis-(3′,5′-dimethylphenyl)-1,5,6,7-tetrahydro-s-indacen-1-yl][2-methyl-4-(3′,5′-dimethylphenyl)-5-methoxy-6-tert-butylinden-1-yl]zirconium dichloride,
rac-anti-dimethylsilanediyl[2-methyl-4,8-bis-(3′,5′-dimethylphenyl)-1,5,6,7-tetrahydro-s-indacen-1-yl][2-methyl-4-(3′,5′-5 ditert-butyl-phenyl)-5-methoxy-6-tert-butylinden-1-yl]zirconium dichloride.

Especially preferred is rac-anti-dimethylsilanediyl[2-methyl-4,8-bis-(3′,5′-dimethylphenyl)-1,5,6,7-tetrahydro-s indacen-1-yl][2-methyl-4-(3′,5′-dimethylphenyl)-5-methoxy-6-tert-butylinden-1-yl]zirconium dichloride.

The ligands required to form the complexes and hence catalysts of the invention can be synthesised by any process and the skilled organic chemist would be able to devise various synthetic protocols for the manufacture of the necessary ligand materials. For Example WO2007/116034 discloses the necessary chemistry. Synthetic protocols can also generally be found in WO 2002/02576, WO 2011/135004, WO 2012/084961, WO 2012/001052, WO 2011/076780, WO 2015/158790 and WO 2018/122134. Especially reference is made to WO 2019/179959, in which the most preferred catalyst of the present invention is described.

### Cocatalyst

To form an active catalytic species it is normally necessary to employ a cocatalyst as is well known in the art.

According to the present invention a co-catalyst system comprising a boron containing co-catalyst and/or an aluminoxane co-catalyst is used in combination with the above defined metallocene catalyst complex.

The aluminoxane co-catalyst can be one of formula (III):

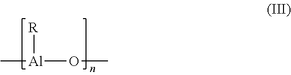

where n is usually from 6 to 20 and R has the meaning below.

Aluminoxanes are formed on partial hydrolysis of organoaluminum compounds, for example those of the formula AlR₃, AlR₂Y and Al₂R₃Y₃ where R can be, for example, C₁-C₁₀ alkyl, preferably C₁-C₅ alkyl, or C₃-C₁₀ cycloalkyl, C₇-C₁₂ arylalkyl or alkylaryl and/or phenyl or naphthyl, and where Y can be hydrogen, halogen, preferably chlorine or bromine, or C₁-C₁₀ alkoxy, preferably methoxy or ethoxy. The resulting oxygen-containing aluminoxanes are not in general pure compounds but mixtures of oligomers of the formula (III).

The preferred aluminoxane is methylaluminoxane (MAO). Since the aluminoxanes used as co-catalysts according to the invention are not, owing to their mode of preparation, pure compounds, the molarity of aluminoxane solutions hereinafter is based on their aluminium content.

According to the present invention, also a boron containing co-catalyst can be used instead of the aluminoxane co-catalyst or the aluminoxane co-catalyst can be used in combination with a boron containing co-catalyst.

It will be appreciated by the person skilled in the art that where boron based co-catalysts are employed, it is normal to pre-alkylate the complex by reaction thereof with an aluminium alkyl compound, such as TIBA. This procedure is well known and any suitable aluminium alkyl, e.g. Al(C₁-C₆ alkyl)₃ can be used. Preferred aluminium alkyl compounds are triethylaluminium, tri-isobutylaluminium, tri-isohexylaluminium, tri-n-octylaluminium and tri-isooctylaluminium.

Alternatively, when a borate co-catalyst is used, the metallocene catalyst complex is in its alkylated version, that is for example a dimethyl or dibenzyl metallocene catalyst complex can be used.

Boron based co-catalysts of interest include those of formula (IV)

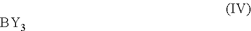

wherein Y is the same or different and is a hydrogen atom, an alkyl group of from 1 to about 20 carbon atoms, an aryl group of from 6 to about 15 carbon atoms, alkylaryl, arylalkyl, haloalkyl or haloaryl each having from 1 to 10 carbon atoms in the alkyl radical and from 6-20 carbon atoms in the aryl radical or fluorine, chlorine, bromine or iodine. Preferred options are trifluoroborane, triphenylborane, tris(4-fluorophenyl)borane, tris(3,5-difluorophenyl)borane, tris(4-fluoromethylphenyl)borane, tris(2,4,6-trifluorophenyl)borane, tris(penta-fluorophenyl)borane, tris(tolyl)borane, tris(3,5-dimethyl-phenyl)borane, tris(3,5-difluorophenyl)borane and/or tris(3,4,5-trifluorophenyl)borane.

Particular preference is given to tris(pentafluorophenyl)borane.

However it is preferred that borates are used, i.e. compounds containing a borate 3+ ion. Such ionic co-catalysts preferably contain a non-coordinating anion such as tetrakis(pentafluorophenyl)borate and tetraphenylborate. Suitable counterions are protonated amine or aniline derivatives such as methylammonium, anilinium, dimethylammonium, diethylammonium, N-methylanilinium, diphenylammonium, N,N-dimethylanilinium, trimethylammonium, triethylammonium, tri-n-butylammonium, methyldiphenylammonium, pyridinium, p-bromo-N,N-dimethylanilinium or p-nitro-N,N-dimethylanilinium.

It has been surprisingly found that certain boron co-catalysts are especially preferred. Preferred borates of use in the invention therefore comprise the trityl ion. Thus the use of N,N-dimethylammonium-tetrakispentafluorophenylborate and Ph₃CB(PhF₅)₄ and analogues therefore are especially favoured.

The preferred co-catalysts are aluminoxanes, more preferably methylaluminoxanes, combinations of aluminoxanes with Al-alkyls, boron or borate co-catalysts, and combination of aluminoxanes with boron-based co-catalysts.

The catalyst system of the invention is used in supported form. The particulate support material used is silica or a mixed oxide such as silica-alumina, in particular silica. The use of a silica support is preferred. The skilled practitioner is aware of the procedures required to support a metallocene catalyst.

In a preferred embodiment, the catalyst system corresponds to the ICS3 of WO 2020/239598 A1.

### Article

In a final aspect, the present invention is directed to an article, more preferably a film, comprising the alpha-nucleated monophasic propylene terpolymer composition (PC) according to either of the first two aspects in an amount of at least 75 wt.-%, more preferably at least 90 wt.-%, most preferably at least 95 wt.-%.

It is preferred that the article is a film, more preferably a cast film or a blown film.

The film may be a monolayer film. Alternatively, the film may be present as a single layer in a multilayer film.

When the film is present as a single layer in a multilayer film the multilayer film can be produced by any means known in the art.

It is preferred that the film has a thickness in the range from 5 to 100 μm, more preferably in the range from 10 to 80 μm, most preferably in the range from 20 to 70 μm.

The film according to the present invention preferably has a clarity value, determined according to ASTM D1003, in the range from 98.0 to 100%, more preferably in the range from 99.0 to 100%, most preferably in the range from 99.5 to 100%.

The film according to the present invention preferably has a haze value, determined according to ASTM D1003, in the range from 0.0 to 4.0%, more preferably in the range from 0.0 to 3.0%, most preferably in the range from 0.0 to 2.5%.

The film according to the present invention preferably has a sealing initiation temperature (SIT) in the range from 100 to 125° C., more preferably in the range from 102 to 120° C., most preferably in the range from 103 to 117° C.

The film according to the present invention preferably has a sealing end temperature (SET) in the range from 115 to 130° C., more preferably in the range from 120 to 128° C., most preferably in the range from 123 to 127° C.

The difference between the sealing end temperature (SET) and the sealing initiation temperature (SIT) of the film according to the present invention is preferably in the range from 10 to 25° C., more preferably in the range from 13 to 22° C., most preferably in the range from 15 to 20° C.

The difference between the melting temperature of the alpha-nucleated monophasic propylene terpolymer composition (PC), determined according to DSC analysis, and the sealing initiation temperature (SIT) of the film according to the present invention, is preferably in the range from 15 to 40° C., more preferably in the range from 18 to 37° C., most preferably in the range from 20 to 34° C.

The film according to the present invention preferably has a maximum sealing force in the range from 10 to 30 N, more preferably in the range from 13 to 27 N, most preferably in the range from 15 to 25 N.

The film according to the present invention preferably has a Hot Tack force, determined according to ASTM F1921-12-Method B, in the range from 2.0 to 5.0 N, more preferably in the range from 2.5 to 4.5 N, most preferably in the range from 3.0 to 4.0 N.

The film according to the present invention preferably has a Hot Tack temperature in the range from 95 to 115° C., more preferably in the range from 100 to 113° C., most preferably in the range from 104 to 111° C.

The film according to the present invention preferably has a 1.5 N Hot Tack sealing process window in the range from 15 to 30° C., more preferably in the range from 17 to 28° C., most preferably in the range from 18 to 27° C.

The film according to the present invention preferably has a tensile storage modulus (E′) in the range from 600 to 1700 MPa, more preferably in the range from 700 to 1600 MPa, most preferably in the range from 750 to 1500 MPa.

The film according to the present invention preferably has a dart drop impact strength, measured according to ASTM D1709-A, in the range from 40 to 550 g, more preferably in the range from 45 to 500 g, most preferably in the range from 50 to 450 g.

The film according to the present invention preferably has a Gloss at 600 in the machine direction, measured according to ISO 2813, in the range from 120 to 170 GU, more preferably in the range from 130 to 160 GU, most preferably in the range from 135 to 150 GU.

The film according to the present invention preferably has a Gloss at 60° in the transverse direction, measured according to ISO 2813, in the range from 120 to 170 GU, more preferably in the range from 130 to 160 GU, most preferably in the range from 135 to 150 GU.

### Cast Film

In one particularly preferred embodiment, the film according to the present invention is a cast film. In this embodiment, it is further preferred that the alpha-nucleated monophasic propylene terpolymer composition (PC) has been visbroken and thus has the properties specified for the visbroken alpha-nucleated monophasic propylene terpolymer composition (PC) described above.

It is preferred that the cast film has a thickness in the range from 5 to 100 μm, more preferably in the range from 10 to 80 μm, most preferably in the range from 20 to 70 μm.

The cast film according to the present invention preferably has a clarity value, determined according to ASTM D1003, in the range from 98.0 to 100%, more preferably in the range from 99.0 to 100%, most preferably in the range from 99.5 to 100%.

The cast film according to the present invention preferably has a haze value, determined according to ASTM D1003, in the range from 0.0 to 1.0%, more preferably in the range from 0.0 to 0.7%, most preferably in the range from 0.0 to 0.5%.

The cast film according to the present invention preferably has a sealing initiation temperature (SIT) in the range from 100 to 120° C., more preferably in the range from 102 to 115° C., most preferably in the range from 103 to 110° C.

The cast film according to the present invention preferably has a sealing end temperature (SET) in the range from 115 to 130° C., more preferably in the range from 120 to 128° C., most preferably in the range from 123 to 127° C.

The difference between the sealing end temperature (SET) and the sealing initiation temperature (SIT) of the cast film according to the present invention is preferably in the range from 10 to 25° C., more preferably in the range from 13 to 22° C., most preferably in the range from 15 to 20° C.

The difference between the melting temperature of the alpha-nucleated monophasic propylene terpolymer composition (PC), determined according to DSC analysis, and the sealing initiation temperature (SIT) of the cast film according to the present invention, is preferably in the range from 25 to 40° C., more preferably in the range from 28 to 37° C., most preferably in the range from 30 to 34° C.

The cast film according to the present invention preferably has a maximum sealing force in the range from 10 to 25 N, more preferably in the range from 13 to 22 N, most preferably in the range from 15 to 20 N.

The cast film according to the present invention preferably has a Hot Tack force, determined according to ASTM F1921-12-Method B, in the range from 2.0 to 5.0 N, more preferably in the range from 2.5 to 4.5 N, most preferably in the range from 3.0 to 4.0 N.

The cast film according to the present invention preferably has a Hot Tack temperature in the range from 95 to 115° C., more preferably in the range from 100 to 110° C., most preferably in the range from 104 to 106° C.

The cast film according to the present invention preferably has a 1.5 N Hot Tack sealing process window in the range from 20 to 30° C., more preferably in the range from 22 to 28° C., most preferably in the range from 23 to 27° C.

The cast film according to the present invention preferably has a tensile storage modulus (E′) in the range from 600 to 1500 MPa, more preferably in the range from 700 to 1200 MPa, most preferably in the range from 750 to 1000 MPa.

The cast film according to the present invention preferably has a dart drop impact strength, measured according to ASTM D1709-A, in the range from 350 to 550 g, more preferably in the range from 380 to 500 g, most preferably in the range from 410 to 450 g.

### Blown Film

In another particularly preferred embodiment, the film according to the present invention is a cast film. In this embodiment, it is further preferred that the alpha-nucleated monophasic propylene terpolymer composition (PC) has not been visbroken and thus has the properties specified for the non-visbroken alpha-nucleated monophasic propylene terpolymer composition (PC) described above.

It is preferred that the blown film has a thickness in the range from 5 to 100 μm, more preferably in the range from 10 to 80 μm, most preferably in the range from 20 to 70 μm.

The blown film according to the present invention preferably has a clarity value, determined according to ASTM D1003, in the range from 98.0 to 100%, more preferably in the range from 99.0 to 100%, most preferably in the range from 99.5 to 100%.

The blown film according to the present invention preferably has a haze value, determined according to ASTM D1003, in the range from 0.0 to 4.0%, more preferably in the range from 0.0 to 3.0%, most preferably in the range from 0.0 to 2.5%.

The blown film according to the present invention preferably has a sealing initiation temperature (SIT) in the range from 110 to 125° C., more preferably in the range from 112 to 120° C., most preferably in the range from 113 to 117° C.

The difference between the melting temperature of the alpha-nucleated monophasic propylene terpolymer composition (PC), determined according to DSC analysis, and the sealing initiation temperature (SIT) of the blown film according to the present invention, is preferably in the range from 15 to 30° C., more preferably in the range from 18 to 27° C., most preferably in the range from 20 to 24° C.

The blown film according to the present invention preferably has a maximum sealing force in the range from 15 to 30 N, more preferably in the range from 18 to 27 N, most preferably in the range from 20 to 25 N.

The blown film according to the present invention preferably has a Hot Tack force, determined according to ASTM F1921-12-Method B, in the range from 2.0 to 5.0 N, more preferably in the range from 2.5 to 4.5 N, most preferably in the range from 3.0 to 4.0 N.

The blown film according to the present invention preferably has a Hot Tack temperature in the range from 100 to 115° C., more preferably in the range from 105 to 113° C., most preferably in the range from 108 to 111° C.

The blown film according to the present invention preferably has a 1.5 N Hot Tack sealing process window in the range from 15 to 25° C., more preferably in the range from 17 to 23° C., most preferably in the range from 18 to 22° C.

The blown film according to the present invention preferably has tensile storage modulus (E′) in the range from 1000 to 1700 MPa, more preferably in the range from 1200 to 1600 MPa, most preferably in the range from 1300 to 1500 MPa.

The blown film according to the present invention preferably has a dart drop impact strength, measured according to ASTM D1709-A, in the range from 40 to 60 g, more preferably in the range from 45 to 57 g, most preferably in the range from 50 to 55 g.

The blown film according to the present invention preferably has a Gloss at 600 in the machine direction, measured according to ISO 2813, in the range from 120 to 170 GU, more preferably in the range from 130 to 160 GU, most preferably in the range from 135 to 150 GU.

The blown film according to the present invention preferably has a Gloss at 60° in the transverse direction, measured according to ISO 2813, in the range from 120 to 170 GU, more preferably in the range from 130 to 160 GU, most preferably in the range from 135 to 150 GU.

All fallback positions provided above for the alpha-nucleated monophasic propylene terpolymer composition (PC) in the first or second aspects are applicable mutatis mutandis to the articles according to the present aspect.

### EXAMPLES

### A. Measuring Methods

The following definitions of terms and determination methods apply for the above general description of the invention including the claims as well as to the below examples unless otherwise defined.

### Quantification of Microstructure by NMR Spectroscopy

Quantitative nuclear-magnetic resonance (NMR) spectroscopy was used to quantify the comonomer content of the polymers.

Quantitative ¹³C{¹H} NMR spectra recorded in the molten-state using a Bruker Avance III 500 NMR spectrometer operating at 500.13 and 125.76 MHz for ¹H and ¹³C respectively. All spectra were recorded using a ¹³C optimised 7 mm magic-angle spinning (MAS) probehead at 180° C. using nitrogen gas for all pneumatics. Approximately 200 mg of material was packed into a 7 mm outer diameter zirconia MAS rotor and spun at 4 kHz. This setup was chosen primarily for the high sensitivity needed for rapid identification and accurate quantification {klimke06, parkinson07, castignolles09}. Standard single-pulse excitation was employed utilising the NOE at short recycle delays of 3 s {pollard04, klimke06} and the RS-HEPT decoupling scheme {fillip05, griffin07}. A total of 1024 (1k) transients were acquired per spectra.

Quantitative ¹³C{¹H} NMR spectra were processed, integrated and relevant quantitative properties determined from the integrals. All chemical shifts are internally referenced to the methyl isotactic pentad (mmmm) at 21.85 ppm.

Characteristic signals corresponding to the incorporation of 1-butene were observed {brandolini01} and the comonomer content quantified.

The amount of isolated 1-butene incorporated in PBP sequences was quantified using the integral of the αB2 sites at 43.6 ppm accounting for the number of reporting sites per comonomer:

$$B = {I}_{α B 2} / 2$$

The amount of consecutively incorporated 1-butene in PBBP sequences was quantified using the integral of the ααB2B2 site at 40.5 ppm accounting for the number of reporting sites per comonomer:

$$BB = 2 * {I}_{αα B 2 B 2}$$

In presence of BB the value of B must be corrected for the influence of the αB2 sites resulting from BB:

$$B = ( {I}_{α B 2} / 2 ) - BB / 2$$

The total 1-butene content was calculated based on the sum of isolated and consecutively incorporated 1-butene:

$${B}_{total} = B + BB$$

Characteristic signals corresponding to the incorporation of ethylene were observed {brandolini01} and the comonomer content quantified.

The amount of isolated ethylene incorporated in PEP sequences was quantified using the integral of the Sop sites at 24.3 ppm accounting for the number of reporting sites per comonomer:

$$E = {I}_{S ββ}$$

If characteristic signals corresponding to consecutive incorporation of ethylene in PEE sequence was observed the Spδ site at 27.0 ppm was used for quantification:

$$EE = {I}_{S βδ}$$

Characteristic signals corresponding to regio defects were observed {resconi00}. The presence of isolated 2,1-erythro regio defects was indicated by the presence of the two methyl sites at 17.7 and 17.2 ppm, by the methylene site at 42.4 ppm and confirmed by other characteristic sites. The presence of 2,1 regio defect adjacent an ethylene unit was indicated by the two inequivalent Sap signals at 34.8 ppm and 34.4 ppm respectively and the Tyy at 33.7 ppm.

The amount of isolated 2,1-erythro regio defects (P_{21e isolated}) was quantified using the integral of the methylene site at 42.4 ppm (Iₑ₉):

$${P}_{21 e isolated} = {I}_{e 9}$$

If present the amount of 2,1 regio defect adjacent to ethylene (P_{E21}) was quantified using the methine site at 33.7 ppm (I_{Tγγ}):

$${P}_{E 21} = {I}_{T γ γ}$$

The total ethylene content was then calculated based on the sum of ethylene from isolated, consecutively incorporated and adjacent to 2,1 regio defects:

$${E}_{t otal} = E + E E + {P}_{B 21}$$

The amount of propene was quantified based on the Sua methylene sites at 46.7 ppm including all additional propene units not covered by Sαα e.g. the factor3*P_{21e isolated} accounts for the three missing propene units from isolated 2,1-erythro regio defects:

$${P}_{total} = {I}_{S α α} + 3 * {P}_{21 e isolated} + B + 0.5 * BB + E + 0.5 * EE + 2 * {P}_{B 21}$$

The total mole fraction of 1-butene and ethylene in the polymer was then calculated as:

$$fB = {B}_{total} / ( {E}_{total} + {P}_{total} + {B}_{total} )$$

$$ffi = {E}_{total} / ( {E}_{total} + {P}_{total} + {B}_{total} )$$

The mole percent comonomer incorporation was calculated from the mole fractions:

$$B [ mol \% ] = 100 * fB$$

$$E [ mol \% ] = 100 * fE$$

The weight percent comonomer incorporation was calculated from the mole fractions:

$$B [ wt . - \% ] = 100 * ( fB * 56.11 ) / ( ( fE * 28.05 ) + ( fB * 56.11 ) + ( ( 1 ( fE + fB ) ) * 42.08 ) )$$

$$E [ wt . - \% ] = 100 * ( fE * 28.05 ) / ( ( fE * 28.05 ) + ( fB * 56.11 ) + ( ( 1 ( fE + fB ) ) * 42.08 ) )$$

The mole percent of isolated 2,1-erythro regio defects was quantified with respect to all propene:

$$[ 21 e ] mol \% = 100 * {P}_{21 e isolated} / {P}_{total}$$

The mole percent of 2,1 regio defects adjacent to ethylene was quantified with respect to all propene:

$$[ E 21 ] mol \% = 100 * {P}_{E 21} / {P}_{total}$$

The total amount of 2,1 defects was quantified as following:

$$[ 21 ] = mol \% = [ 21 e ] + [ E 21 ]$$

Characteristic signals corresponding to other types of regio defects (2,1-threo, 3,1 insertion) were not observed {resconi00}.

### Literature (as Referred to Above)

klimke06 Klimke, K., Parkinson, M., Piel, C., Kaminsky, W., Spiess, H. W., Wilhelm, M., Macromol. Chem. Phys. 2006; 207:382.
parkinson07 Parkinson, M., Klimke, K., Spiess, H. W., Wilhelm, M., Macromol. Chem. Phys. 2007; 208:2128.
pollard04 Pollard, M., Klimke, K., Graf, R., Spiess, H. W., Wilhelm, M., Sperber, O., Piel, C., Kaminsky, W., Macromolecules 2004; 37:813.
filip05 Filip, X., Tripon, C., Filip, C., J. Mag. Resn. 2005, 176, 239
griffin07 Griffin, J. M., Tripon, C., Samoson, A., Filip, C., and Brown, S. P., Mag. Res. in Chem. 2007 45, S i, S198.
castignolles09 Castignolles, P., Graf, R., Parkinson, M., Wilhelm, M., Gaborieau, M., Polymer 50 (2009) 2373.
resconi00 Resconi, L., Cavallo, L., Fait, A., Piemontesi, F., Chem. Rev. 2000, 100, 1253.
brandolini01 A. J. Brandolini, D. D. Hills, “NMR spectra of polymers and polymer additives”, Marcel Deker Inc., 2000

Calculation of comonomer content of the second random terpolymer fraction (PP2):

$$\frac{C ( P P ) - w ( P P 1 ) x C ( P P 1 )}{w ( P P 2 )} = C ( P P 2 ) \qquad ( I )$$

wherein
w(PP1) is the weight fraction [in wt.-%] of the first random terpolymer fraction (PP1),
w(PP2) is the weight fraction [in wt.-%] of second random terpolymer fraction (PP2),
C(PP1) is the comonomer content [in mol-%] of the first random terpolymer fraction (PP1),
C(PP) is the comonomer content [in mol-%] of the propylene/ethylene/1-butene random terpolymer (PP),
C(PP2) is the calculated comonomer content [in mol-%] of the second random terpolymer fraction (R-PP2).

### Melt Flow Rate

The melt flow rate (MFR) is determined according to ISO 1133 and is indicated in g/10 min.

The MFR is an indication of the flowability, and hence the processability, of the polymer.

The higher the melt flow rate, the lower the viscosity of the polymer. The MFR₂of polypropylene is determined at a temperature of 230° C. and a load of 2.16 kg.

Calculation of melt flow rate MFR₂ (230° C.) of the second random terpolymer fraction (PP2):

$$MFR ( P P 2 ) = {10}^{[ \frac{log ( MFR ( P P ) ) - w ( P P ) x log ( MFR ( P P 1 ) )}{w ( P P 2 )} ]} \qquad ( II )$$

wherein
w(PP1) is the weight fraction [in wt.-%] of the first random terpolymer fraction (PP1),
w(PP2) is the weight fraction [in wt.-%] of second random terpolymer fraction (PP2),
MFR(PP1) is the melt flow rate MFR₂ (230° C.) [in g/10 min] of the first random terpolymer fraction (PP1),
MFR(PP) is the melt flow rate MFR₂ (230° C.) [in g/10 min] of the propylene/ethylene/1-butene random terpolymer (PP),
MFR(PP2) is the calculated melt flow rate MFR₂ (230° C.) [in g/10 min] of the second random terpolymer fraction (PP2).

The xylene soluble fraction at room temperature (XCS, wt.-%): The amount of the polymer soluble in xylene is determined at 25° C. according to ISO 16152; 5^{th} edition; 2005-07-01.

DSC analysis, melting temperature (Tₘ) and heat of fusion (Hₘ), crystallization temperature (T_{c}) and heat of crystallization (H_{c}): measured with a TA Instrument Q200 differential scanning calorimetry (DSC) on 5 to 7 mg samples. DSC is run according to ISO 11357/part 3/method C2 in a heat/cool/heat cycle with a scan rate of 10° C./min in the temperature range of −30 to +225° C. Crystallization temperature (T_{c}) and heat of crystallization (H_{c}) are determined from the cooling step, while melting temperature (Tₘ) and heat of fusion (Hₘ) are determined from the second heating step.

The glass transition temperature Tg is determined by dynamic mechanical analysis according to ISO 6721-7. The measurements are done in torsion mode on compression moulded samples (40×10×1 mm³) between −100° C. and +150° C. with a heating rate of 2° C./min and a frequency of 1 Hz.

Haze and clarity are determined according to ASTM D1003 on cast films or blown films with a thickness of 50 m produced as indicated below.

Tensile storage modulus (E′)

In a dynamic mechanical thermal analysis in tensile mode, the sample is subjected to a constant load together with an applied sinusoidal tensile strain. Under low deformation, the material response is kept within the linear viscoelastic region, which is independent of strain amplitude.

The tensile storage modulus E′ (1) is determined from the following equations

$${E}^{′} = \frac{Δ {F}_{A}}{{s}_{A}} * \frac{{L}_{a}}{b d} * cos δ [ Pa ] \qquad ( 1 )$$

where
ΔF_{A} is the measured amplitude of dynamic force, in newton
s_{A} is the measured amplitude of the dynamic displacement, in metres
Lₐ is the distance between the clamps, in metres
b is the width of the specimen, in metres
d is the thickness of the specimen, in metres
δ is the measured phase angle, in degrees.

The characterization of dynamic-mechanic properties complies with ISO standards 6721-1, 6721-4, 6721-11. The measurements were performed on a “Netzsch DMA 242E Artemis” strain/stress-controlled dynamic mechanical analyzer, equipped with a tensional-sample holder for rectangular specimen geometry. Measurements were undertaken on rectangular specimens cut from the films. The dynamic mechanic thermal analysis was performed under inert atmosphere within the temperature range from −40° C. to +150° C. while using liquid nitrogen for cooling and a heating rate of 2 K/min. The test parameters used include a frequency of 1 Hz, in strain-stress controlled mode with a maximum dynamic applied stress of 1.70 MPa, a static load of 0.20 MPa and a maximum strain of 0.20%. The evaluation was performed using the software “Proteus Thermal Analysis—Version 6.1.0” to calculate the E′ at 23° C.

### REFERENCES

[1]“Dynamic mechanical analysis: a practical introduction” Kevin P. Menard© 2008 by Taylor & Francis Group, LLC, Dynamic Testing and Instrumentation, 71-76, 2008

Hot Tack Force was determined according to a modified method based on ASTM F1921-12-Method B on a J&B Hot-Tack Tester on a 50 m or 40 m thickness film depending on the production method.

### Specimen Cutter:

A rotary drum cutter or a strip cutter is used to cut the specimens to a width of 25 mm (0,5%).

### Testing Machine:

Seal bar length: 50 mm
Seal bar width: 5 mm
Seal bar shape: flat
Seal bar material: brass-nickel
Coating of sealing bars: NIPTEF®
Roughness of sealing bars: approx. 1 μm
Force measurement: Piezo electric force transducer
Temperature measurement: 2 separate heating systems
   Thickness-measuring device: (accuracies according to ISO 4593:1993)
Positionsanzeige (Heidenhain; Type: ND 280)
Messtaster (Heidenhain; Type: MT 1281)
Measuring surfaces: plane/plane polished
Diameter of each face: 6.5 mm

### Conditioning of Samples/Test Specimens:

All test specimens have to be prepared in standard atmospheres for conditioning and testing at 23° C. (±2° C.) and 50% (±10%) relative humidity.
Minimum conditioning time of test specimen in standard atmosphere before testing: >16 h.
Minimum storage time between extrusion of film sample and testing: >88 h.
   Specimen preparation:
Specimen type: parallel cut stripes with 25 mm (width)×approx. 320 mm (length) taken over the whole width of sample.
Specimen orientation: Machine direction
Specimens (films) shall be free from dust, fingerprints, wrinkles, folds, shrivelling or other obvious imperfections. The edges of cut specimens shall be smooth and free from notches.

### Thickness Measurement:

The thickness of the test specimen is measured in the sealing area.

### Hot Tack —Sealing Process:

The test shall be carried out in the same atmospheric conditions as the conditioning. The prepared specimen strip is sealed by applying pressure from two heated flat seal jaws (NIPTEF®, 5*50 mm) under defined conditions of temperature, contact time and pressure. The specimen is folded between the sealing jaws with an automatic specimen-folding device. Sealing jaws close and after the pre-set sealing time elapse, the sealing jaws open and the heat seal is complete. The selected cooling time elapses and the lower sample clamp moves down, pulling the specimen along. In that step, the force transducer, attached to the upper sample clamp, measures the force. Afterwards the failure mode is determined visually.

### Standard Test Conditions:

Sealing time (1 s)
Sealing pressure (0.15 N/mm²)
Delay time (0,2 s)
Clamp separation rate (200 mm/s)
Number of test specimens: at least 3 specimens per temperature

In case the measured values at one temperature step show significant deviation, one additional specimen, at that temperature step, is tested to ensure the data points are outliers. However, the number of specimens should always be uneven but the total should not exceed 7 tested specimens. The outlier is allowed only to be eliminated from the measurement once it is confirmed; whereas, deviation caused by other reasons must be considered.

Temperature steps/interval: ramp upwards by 5° C.

(2° C. upward ramp in case of sharp increase/decrease between two temperature steps) Start measuring at two temperature steps below 0,2-0,3 N.

Stop measuring at failure mode burn-through.

It is allowed to have one failure mode with burn-through and two other failure modes, only with one additional temperature step.

A typical hot-tack curve may require 25 to 50 specimens of each material.

### Results:

The output of this method is a hot-tack curve. The interpretation of hot-tack curves has always rested on the relationship between sealing force and sealing temperature.

Hot-Tack is defined as the highest force with failure mode “peel”. Also allowed are two “peel” failure modes and any other failure mode (except burn-through failure mode) when three specimens/temperature step are used.

1.5 N Hot Tack sealing process window: To determine the Hot-Tack sealing initiation temperature, the measured hot-tack forces vs sealing temperature are fitted with a sigmoidal function.

$$F = \frac{p}{( 1 + exp ( \frac{( w - T )}{s} ) )} \qquad ( Eq . 1 )$$

Where F is the average Hot-Tack sealing force, T is the sealing temperature, p, w and s are fitting parameters. After fitting, the Hot-Tack sealing initial temperature is calculated by setting F equal to 1.5 N.

$$T = w - s ln ( ( \frac{P}{F} ) - 1 ) \qquad ( Eq . 2 )$$

The Hot-tack process window ends at the temperature where any failure mode besides adhesive Peel or Peel-elongation is observed. Thus, two temperatures are also reported:
Hot-Tack sealing initial temperature [° C.] denoted in Table 2 as Hot Tack over 1.5 N (IT)
Hot Tack sealing end temperature [° C.] denoted in Table 2 as Hot Tack over 1.5 N (ET)

Deviating from ASTM F1921-12 Chapter 9, the test is performed after a cooling time of 200 ms. The end of the measurement described in chapter 9.8 of ASTM F1921-12 (test stop after determination of the Hot Tack) is not considered. End of test is instead considered after the thermal failure of the film. In addition to failure mode evaluations described in the standard, additional failure modes are used.

### Sealing Range Experiments (SIT, Max Sealing Force and SET)

This method is used to determine the sealing window (sealing temperature range) of films. The procedure is similar to Hot-Tack test and is conducted in the same machine. In contrast to Hot-Tack, the sealing range determined corresponds to the strength of the seal after it had cooled down (a delay time of 30 s). The conditions used are as follows:
Sealing time (1 s)
Sealing pressure (0.4 N/mm²)
Delay time (30 s)
Clamp separation rate (42 mm/s)

$$Sealing range = ( Seal initiation temperature until seal end temperature )$$

The determined results provide a quantitatively useful indication of the sealing strength of the films and indicate the temperature range for optimal sealing.

The lower limit (Sealing Initiation Temperature—SIT) is the sealing temperature at which a sealing average force of ≥5 N is measured. The upper limit (Sealing End Temperature —SET) is identified as the first sealing temperature where at least two specimens showed a burn-through failure mode. The maximum sealing force corresponds to the highest measured sealing force.

The temperature interval is set by default to 5° C., but can be reduced to 1° C. when the curve shows a sharp increase or decrease in the force values between two temperature steps. This is done in order to represent a better curve profile.

Deviating from ASTM F1921-12, the test parameters sealing pressure, cooling time and test speed are modified. The determination of the force/temperature curve is continued until thermal failure of the film. In addition to failure mode evaluations described in the standard, additional failure modes are used.

### DDI

ISO 7765-1:1988/Method A

This test method covers the determination of the energy that causes films to fail under specified conditions of impact of a free-falling dart from a specified height that would result in failure of 50% of the specimens tested (Staircase method A). A uniform missile mass increment is employed during the test and the missile weight is decreased or increased by the uniform increment after test of each specimen, depending upon the result (failure or no failure) observed for the specimen.

Standard conditions:
Conditioning time: >96 h
Test temperature: 23° C.
Dart head material: phenolic
Dart diameter: 38 mm
Drop height: 660 mm

### Results:

Impact failure mass [g]
Minimum thickness [mm]
Maximum thickness [mm]

Testing according to ISO7765-1:1988/Method A was carried out on films with a thickness as indicated and produced as described below under “Examples” and reported in gram (g). DDI per unit thickness (in g/micron) is calculated by dividing DDI (in gram) to the thickness of film (in micron) Gloss @60° was determined according to ISO 2813.

### B. Examples

The catalyst used in the polymerization process for all examples was Anti-dimethylsilanediyl[2-methyl-4,8-di(3,5-dimethylphenyl)-1,5,6,7-tetrahydro-s-indacen-1-yl][2-methyl-4-(3,5-dimethylphenyl)-5-methoxy-6-tert-butylinden-1-yl]zirconium dichloride as disclosed in WO 2019/179959 A1 as MC-2. The supported metallocene catalyst was produced analogously to IE2 in WO 2019/179959 A1.

PP-1 was polymerized according to the conditions given in Table 1 (note: The MFR₂, C2 and C4 content given after reactor R2 are the properties of the GPR fraction and were calculated from the values measured after the loop reactor (i.e. PP1) and in the final pellets (i.e. PP), using appropriate mixing rules).

TABLE 1
Polymerization conditions of the propylene/ethylene/1-
butene terpolymer

PP-1

Prepolymerization (R0)

| | | |
|---|---|---|
| Temperature | [° C.] | 20 |
| Pressure | [kPa] | 5300 |
| Residence time | [h] | 0.34 |

Loop (R1)

| | | |
|---|---|---|
| Temperature | [° C.] | 65 |
| Pressure | [kPa] | 5300 |
| H2/C3 ratio | [mol/kmol] | 0.10 |
| C2/C3 ratio | [mol/kmol] | 17.8 |
| C4/C3 ratio | [mol/kmol] | 37.8 |
| split | [wt.-%] | 57 |
| MFR₂ | [g/10 min] | 6.4 |
| C2 content | [mol-%] | 2.7 |
| C4 content | [mol-%] | 2.4 |

GPR (R2)

| | | |
|---|---|---|
| Temperature | [° C.] | 75 |
| Pressure | [kPa] | 2200 |
| H2/C3 ratio | [mol/kmol] | 1.4 |
| C2/C3 ratio | [mol/kmol] | 109 |
| C4/C3 ratio | [mol/kmol] | 47.3 |
| split | [wt.-%] | 37 |
| MFR₂ | [g/10 min] | 8.3 |
| C2 content | [mol-%] | 2.7 |
| C4 content | [mol-%] | 5.0 |

Pellets

| | | |
|---|---|---|
| MFR2 | [g/10 min] | 6.8 |
| XCS | [wt.-%] | 2.2 |
| C2 content | [mol-%] | 2.7 |
| C4 content | [mol-%] | 3.5 |
| 2,1 regiodefects | [mol-%] | 0.40 |

Blown films (RE1, IE1, and CE1) and cast films (RE2, IE2, and CE2) were prepared from PP-1, following the recipes given in Table 2. The compounding was done on a ZSK 18 twin screw extruder, operated at 210° C., production rate of 7 kg/h. For the cast film examples, the MFR₂ was adjusted to approx. 30 g/10 min by visbreaking with a peroxide visbreaking agent (DHBP). The amount of peroxide required to achieve this MFR₂ outcome can be straightforwardly determined by the person skilled in the art.

The blown films were prepared on a Collin 30 lab scale blown film line. The melt temperature is 210° C., film thickness is 50 μm, BUR 1:2.5, uptake speed 7m/min. The cast films were prepared on a Collin 30 lab scale cast film line. The melt temperature is 250° C., film thickness is 50 μm, uptake speed 7m/min. The properties of the blown films and cast films produced prepared from PP-1 are given in Table 3.

TABLE 2
Recipes for reference, inventive and comparative examples

| | | RE1 | IE1 | CE1 | RE2 | IE2 | CE2 |
|---|---|---|---|---|---|---|---|
| PP-1 | [wt.-%] | 99.80 | 99.70 | 99.40 | 96.80 | 96.45 | 96.40 |
| AO | [wt.-%] | 0.15 | 0.15 | 0.15 | 0.15 | 0.15 | 0.15 |
| SHT | [wt.-%] | 0.05 | 0.05 | 0.05 | 0.05 | 0.05 | 0.05 |
| NU1 | [wt.-%] | — | 0.10 | — | — | 0.10 | — |
| NU2 | [wt.-%] | — | — | 0.40 | — | — | 0.40 |
| DHBP | [wt.-%] | — | — | — | 3.00 | 3.25 | 3.00 |

AO Irganox B215, a synergistic 2:1 blend of antioxidants Irgafos 168 (tris(2,4-ditert-butylphenyl)phosphite, CAS No: 31570-04-4) and Irganox 1010 (pentaerythritol tetrakis[3-[3,5-di-tert-butyl-4-hydroxyphenyl]propionate], CAS No: 6683-19-8), available from BASF SE.
SHT synthetic hydrotalcite, available from Kisuma Chemicals under the trade name DHT-4A.
NU1 a particulate blend, comprising 2,2′-methylene bis-(2,6-di-tert. butylphenyl) phosphate lithium salt as the major component, available from Adeka Corp. under the trade name ADK STAB NA-71.
NU2 1,2,3-trideoxy-4,6:5,7-bis-O-((4-propylphenyl) methylene) nonitol, CAS No: 882073-43-0, available from Milliken & Company under the trade name Millad NX8000.
DHBP 2,5-dimethyl-2,5-di-(tert-butylperoxy)hexane, CAS No: 78-63-7, available from United Initiators.

TABLE 3
Film properties of reference, inventive and comparative examples

| | | | | | |
|---|---|---|---|---|---|
| RE1 | IE1 | CE1 | RE2 | IE2 | CE2 |

Polymer Properties

| | | | | | | | |
|---|---|---|---|---|---|---|---|
| MFR₂ | [g/10 min] | 6.9 | 7.9 | 7.9 | 29.6 | 30.9 | 30.3 |
| T_{c} | [° C.] | 96 | 107 | 109 | 97 | 109 | 111 |
| H_{c} | [J/g] | 70.8 | 74.2 | 73.2 | 76.2 | 76.2 | 76.3 |
| ΔTc (relative to RE) | [° C.] | n/a | 11 | 13 | n/a | 12 | 14 |
| Tₘ2 | [° C.] | 133 | 136 | 137 | 134 | 138 | 140 |
| Hₘ2 | [J/g] | 72.3 | 74.3 | 72.7 | 72.4 | 75.8 | 74.6 |
| ΔTₘ2 (relative to RE) | [° C.] | n/a | 3 | 4 | n/a | 4 | 6 |

50 um Film Properties

| | | | | | | | |
|---|---|---|---|---|---|---|---|
| Film type | n/a | Blown | Blown | Blown | Cast | Cast | Cast |
| Clarity | [%] | 99.1 | 99.7 | 99.2 | 100.0 | 99.5 | 100.0 |
| Haze | [%] | 4.85 | 2.23 | 1.46 | 0.11 | 0.39 | 0.16 |
| SIT | [° C.] | 114 | 115 | 125 | 108 | 106 | 113 |
| SET | [° C.] | >130 | >130 | 130 | 120 | 125 | 120 |
| SET-SIT | [° C.] | >16 | >15 | 5 | 12 | 19 | 7 |
| Tm-SIT | [° C.] | 19 | 21 | 12 | 26 | 32 | 27 |
| Max sealing force | [N] | 22.7 | 22.4 | 16.4 | 15.6 | 15.4 | 17.1 |
| Hot Tack temp | [° C.] | 105 | 109 | 110 | 95 | 105 | 106 |
| Hot Tack force | [N] | 3.27 | 3.35 | 2.09 | 2.75 | 3.5 | 3.14 |
| Hot Tack over 1.5N (IT) | [° C.] | 101 | 100 | 109 | 92 | 90 | 95 |
| Hot Tack over 1.5N (ET) | [° C.] | 115 | 120 | 116 | 110 | 115 | 110 |
| 1.5N Hot Tack window | [° C.] | 14 | 20 | 7 | 18 | 25 | 15 |
| E′ @ 23° C., 1 Hz | [MPa] | 1070 | 1330 | 1400 | 730 | 780 | 810 |
| DDI | [g] | 55 | 51 | 43 | 460 | 430 | 446 |
| Gloss 60° MD | [GU] | 121 | 140 | 143 | n.m. | n.m. | n.m. |
| Gloss 60° TD | [GU] | 119 | 138 | 144 | n.m. | n.m. | n.m. |

n.m.—not measured.

As can be seen from Table 3, the use of a particulate nucleating agent in the inventive films, both cast and blown, leads to wider 1.5 N Hot Tack sealing process windows than for the films with no nucleation (i.e. RE1 and RE2 respectively). The soluble nonitol nucleating agent, on the other hand, result in narrower 1.5 N Hot Tack sealing process windows than the reference examples (CE1/CE2 vs. RE1/RE2). It can also be seen that a similar trend is observed for the Tm-SIT parameter. For the blown films, IE1 has a much-improved clarity relative to both RE1 and CE 1. The inventive blown films and cast films have notably improved Hot Tack force over both the reference (no nucleation) and comparative (nonitol-nucleation) examples. Furthermore, for the blown films, IE 1 has a considerably higher max sealing force than CE1 (i.e. the nonitol-nucleated blown film). The same is true for DDI in blown films, with the decrease in DDI due to nucleation being considerably lower for IE 1 than for CE1. In many other features (e.g. Haze, Gloss, E′), the inventive compositions show improvements over the non-nucleated reference examples that are similar to the improvements observed in the comparative examples.

As has been demonstrated, the use of particulate nucleating agents with the specific terpolymers of the invention allows the person skilled in the art to obtain compositions/films having notably improved sealing and mechanical properties, as well as optical properties (gloss) that are improved over the non-nucleated composition. Soluble nucleating agents have been demonstrated to be inferior to the inventive particular nucleating agents over a wide range of metrics.

1. An alpha-nucleated monophasic propylene terpolymer composition (PC), comprising:
a) a propylene/ethylene/1-butene random terpolymer (PP), having:
i) an ethylene content (C2), as determined by quantitative ¹³C-NMR spectroscopy, in the range from 0.75 to 4.0 mol %;
ii) a 1-butene content (C4), as determined by quantitative ¹³C-NMR spectroscopy, in the range from 2.0 to 7.5 mol %; and
iii) a content of 2,1-regiodefects, as determined by quantitative ¹³C-NMR spectroscopy analysis, in the range from 0.1 to 1.5 mol %, and
b) one or more alpha nucleating agents (NU), wherein at least one of the one or more alpha nucleating agents is a particulate alpha nucleating agent,
wherein the total amounts of the propylene/ethylene/1-butene random terpolymer (PP) and the one or more alpha nucleating agents (NU) add up to at least 95 wt. % of the total weight of the alpha-nucleated monophasic propylene terpolymer composition (PC),
wherein the alpha-nucleated monophasic propylene terpolymer composition (PC) has each of the following properties:
i) a melt flow rate (MFR₂), determined according to ISO 1133 at 230° C. at a load of 2.16 kg, in the range from 1.0 to 35 g/10 min;
ii) a melting temperature, determined according to DSC analysis, in the range from 125 to 140° C.; and
iii) a crystallization temperature, determined according to DSC analysis, in the range from 95 to 115° C.

2. The alpha-nucleated monophasic propylene terpolymer composition (PC) according to claim 1, wherein at least one of the one or more alpha nucleating agents (NU) is a particulate alpha nucleating agent comprising a compound having a phosphate moiety.

3. The alpha-nucleated monophasic propylene terpolymer composition (PC) according to claim 2, wherein at least one of the one or more alpha nucleating agents (NU) is a particulate alpha nucleating agent that comprises a compound having the structure [(Ar¹O)(Ar²O)(O═)P—O]ₙX, wherein
Ar¹ and Ar² are each independently selected from phenyl groups substituted by one or more C₁ to C₆ linear or branched alkyl groups, wherein Ar¹ and Ar² may also be linked by a direct single bond, an O, or a C₁ to C₆ alkylene group,
n is either 1 or 2, wherein if n=1, then X is selected from the group consisting of Li, Na, K, and Al(OH)₂, and if n=2, then X is selected from the group consisting of Mg, Ca, and Al(OH).

4. The alpha-nucleated monophasic propylene terpolymer composition (PC), according to claim 3, wherein at least one of the one or more alpha nucleating agents (NU) is a particulate alpha nucleating agent comprising a compound selected from the group consisting of sodium di(4-tert-butylphenyl)phosphate, sodium 2,2′-methylene-bis-(4,6-di-tert.butylphenyl) phosphate, lithium 2,2′-methylene-bis-(4,6-di-tert.butylphenyl) phosphate, and aluminium hydroxybis[2,2′methylene-bis(4,6-di-tert-butylphenyl)phosphate].

5. The alpha-nucleated monophasic propylene terpolymer composition (PC) according to claim 1, wherein the melting temperature of the alpha-nucleated monophasic propylene terpolymer composition (PC) is 1.0 to 6.0° C. higher than the melting temperature of the propylene/ethylene/1-butene random terpolymer (PP), both melting temperatures being determined according to DSC analysis, and/or
wherein the crystallization temperature of the alpha-nucleated monophasic propylene terpolymer composition (PC) is 5.0 to 15.0° C. higher than the crystallization temperature of the propylene/ethylene/1-butene random terpolymer (PP), both crystallization temperatures being determined according to DSC analysis.

6. The alpha-nucleated monophasic propylene terpolymer composition (PC) according to claim 1, wherein the propylene/ethylene/1-butene random terpolymer (PP) comprises:
a) 40 to 80 wt. %, relative to the total weight of the propylene/ethylene/1-butene random terpolymer (PP), of a first random terpolymer fraction (PP1), having an ethylene content (C2), as determined by quantitative ¹³C-NMR spectroscopy, in the range from 0.75 to 4.0 mol %, and a 1-butene content (C4), as determined by quantitative ¹³C-NMR spectroscopy, in the range from 1.0 to 5.0 mol %; and
b) 20 to 60 wt. %, relative to the total weight of the propylene/ethylene/1-butene random terpolymer (PP), of a second random terpolymer fraction (PP2), having an ethylene content (C2), as determined by quantitative ¹³C-NMR spectroscopy, in the range from 0.75 to 4.0 mol %, and a 1-butene content (C4), as determined by quantitative ¹³C-NMR spectroscopy, in the range from 3.0 to 10.0 mol %,
wherein the first random terpolymer fraction (PP1) and the second random terpolymer fraction (PP2) combined make up at least 95 wt. % of the total weight of the propylene/ethylene/1-butene random terpolymer (PP).

7. The alpha-nucleated monophasic propylene terpolymer composition (PC) according to claim 6, wherein the ratio of the ethylene content of the propylene/ethylene/1-butene random terpolymer (PP) to the ethylene content of the first random terpolymer fraction (PP1), both determined by quantitative ¹³C-NMR spectroscopy and expressed in mol %, ([C2(PP)]/[C2(PP1)]) is in the range from 0.70 to 1.30, and/or
the ratio of the 1-butene content of the propylene/ethylene/1-butene random terpolymer (PP) to the 1-butene content of the first random terpolymer fraction (PP1), both determined by quantitative ¹³C-NMR spectroscopy and expressed in mol %, ([C4(PP)]/[C4(PP1)]) is in the range from 1.00 to 2.00.

8. The alpha-nucleated monophasic propylene terpolymer composition (PC) according to claim 1, wherein the propylene/ethylene/1-butene random terpolymer (PP) has been formed by visbreaking a precursor propylene/ethylene/1-butene random terpolymer (PP′) using a visbreaking agent.

9. An alpha-nucleated monophasic propylene terpolymer composition (PC) having:
i) an ethylene content (C2), as determined by quantitative ¹³C-NMR spectroscopy, in the range from 0.75 to 4.0 mol %;
ii) a 1-butene content (C4), as determined by quantitative ¹³C-NMR spectroscopy, in the range from 2.0 to 7.5 mol %;
iii) a melt flow rate (MFR₂), determined according to ISO 1133 at 230° C. at a load of 2.16 kg, in the range from 1.0 to 35 g/10 min;
iv) a melting temperature, determined according to DSC analysis, in the range from 125 to 140° C.; and
v) a crystallization temperature, determined according to DSC analysis, in the range from 95 to 115° C.,
wherein the alpha-nucleated monophasic propylene terpolymer composition (PC) furthermore has:
a) a 1.5 N Hot Tack sealing process window, measured on a 50 μm blown film sample, in the range from 15 to 25° C., or
b) a 1.5 N Hot Tack sealing process window, measured on a 50 μm cast film sample, in the range from 20 to 30° C.

10. A process for producing the alpha-nucleated monophasic propylene terpolymer composition (PC) according to claim 1, comprising the steps of:
a) polymerizing propylene, ethylene and 1-butene comonomer units in a first polymerization reactor in the presence of a single-site catalyst to produce a first polymerization mixture comprising the first random terpolymer fraction (PP1) and the single-site catalyst;
b) withdrawing said first polymerization mixture from the first polymerization reactor and optionally carrying out steps c1) through c3) prior to step d)
c1) transferring the first polymerization mixture into a second polymerization reactor;
c2) polymerizing propylene, ethylene and 1-butene comonomer units in said second polymerization reactor in the presence of said single-site catalyst to produce a second polymerization mixture comprising the first random terpolymer fraction (PP1), the second random terpolymer fraction (PP2) and the single-site catalyst;
c3) withdrawing said second polymerization mixture from said second polymerization reactor; and
d) compounding the first polymerization mixture if steps c1) to c3) are not present, or the second polymerization mixture if steps c1) to c3) are present, with the one or more alpha nucleating agents (NU), optionally with a visbreaking agent (V) and optionally with the addition of further additives to form the alpha-nucleated monophasic propylene terpolymer composition (PC).

11. The process according to claim 10, wherein the single site catalyst comprises:
(i) a metallocene complex of the general formula (II) 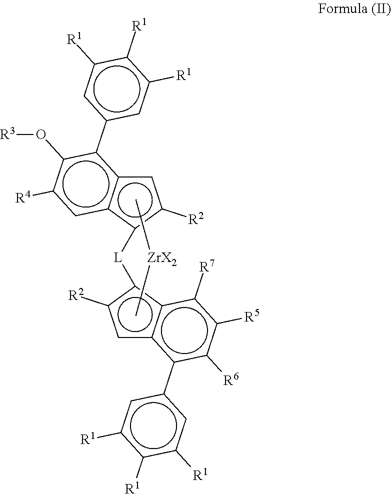
wherein each X independently is a sigma-donor ligand,
L is a divalent bridge selected from —R′₂C—, —R′₂C—CR′₂—, —R′₂Si—, —R′₂Si—SiR′₂—, —R′₂Ge—, wherein each R′ is independently a hydrogen atom or a C₁-C₂₀-hydrocarbyl group optionally containing one or more heteroatoms from groups 14-16 of the periodic table or fluorine atoms, or optionally two R′ groups taken together can form a ring,
each R¹ are independently the same or can be different and are hydrogen, a linear or branched C₁-C₆-alkyl group, a C₇₋₂₀-arylalkyl, C₇₋₂₀-alkylaryl group or C₆₋₂₀-aryl group or an OY group, wherein Y is a C₁₋₁₀-hydrocarbyl group, and optionally two adjacent R¹ groups can be part of a ring including the phenyl carbons to which they are bonded,
each R² independently are the same or can be different and are a CH₂—R⁸ group, with R⁸ being H or linear or branched C₁₋₆-alkyl group, C₃₋₈-cycloalkyl group, C₆₋₁₀-aryl group,
R³ is a linear or branched C₁-C₆-alkyl group, C₇₋₂₀-arylalkyl, C₇₋₂₀-alkylaryl group or C₆-C₂₀-aryl group,
R⁴ is a C(R⁹)₃ group, with R⁹ being a linear or branched C₁-C₆-alkyl group,
R⁵ is hydrogen or an aliphatic C₁-C₂₀-hydrocarbyl group optionally containing one or more heteroatoms from groups 14-16 of the periodic table;
R⁶ is hydrogen or an aliphatic C₁-C₂₀-hydrocarbyl group optionally containing one or more heteroatoms from groups 14-16 of the periodic table; or
R⁵ and R⁶ can be taken together to form a 5 membered saturated carbon ring which is optionally substituted by n groups R¹⁰, n being from 0 to 4;
each R¹⁰ is same or different and may be a C₁-C₂₀-hydrocarbyl group, or a C₁-C₂₀-hydrocarbyl group optionally containing one or more heteroatoms belonging to groups 14-16 of the periodic table;
R⁷ is H or a linear or branched C₁-C₆-alkyl group or an aryl or heteroaryl group having 6 to 20 carbon atoms optionally substituted by one to three groups R¹¹,
each R¹¹ are independently the same or can be different and are hydrogen, a linear or branched C₁-C₆-alkyl group, a C₇₋₂₀-arylalkyl, C₇₋₂₀-alkylaryl group or C₆₋₂₀-aryl group or an OY group, wherein Y is a C₁₋₁₀-hydrocarbyl group,
(ii) a co-catalyst system comprising a boron containing co-catalyst and/or an aluminoxane co-catalyst, and
(iii) a silica support.

12. The alpha-nucleated monophasic propylene terpolymer composition (PC) according to claim 1, wherein a process comprising the steps of:
a) polymerizing propylene, ethylene and 1-butene comonomer units in a first polymerization reactor in the presence of a single-site catalyst to produce a first polymerization mixture comprising the first random terpolymer fraction (PP1) and the single-site catalyst;
b) withdrawing said first polymerization mixture from the first polymerization reactor and optionally carrying out steps c1) through c3) prior to step d)
c1) transferring the first polymerization mixture into a second polymerization reactor;
c2) polymerizing propylene, ethylene and 1-butene comonomer units in said second polymerization reactor in the presence of said single-site catalyst to produce a second polymerization mixture comprising the first random terpolymer fraction (PP1), the second random terpolymer fraction (PP2) and the single-site catalyst;
c3) withdrawing said second polymerization mixture from said second polymerization reactor; and
d) compounding the first polymerization mixture if steps c1) to c3) are not present, or the second polymerization mixture if steps c1) to c3) are present, with the one or more alpha nucleating agents (NU), optionally with a visbreaking agent (V) and optionally with the addition of further additives to form the alpha-nucleated monophasic propylene terpolymer composition (PC).

13. An article comprising the alpha-nucleated monophasic propylene terpolymer composition (PC) according to claim 1 in an amount of at least 75 wt. %.

14. The article according to claim 13 being a blown film, having one or more of the following properties:
a) a sealing initiation temperature (SIT) in the range from 110 to 125° C.,
b) a Hot Tack Force, determined according to ASTM F1921-12-Method B, in the range from 2.0 to 5.0 N,
c) a dart drop impact strength, measured according to ASTM D1709-A, in the range from 40 to 60 g,
d) a haze value, determined according to ASTM D1003, in the range from 0.0 to 4.0%,
e) a clarity value, determined according to ASTM D1003, in the range from 98.0 to 100%, and
f) a 1.5 N Hot Tack sealing process window in the range from 15 to 25° C.

15. The article according to claim 13 being a cast film, having one or more of the following properties:
a) a sealing initiation temperature (SIT) in the range from 100 to 120° C.,
b) a Hot Tack Force, determined according to ASTM F1921-12-Method B, in the range from 2.0 to 5.0 N,
c) a dart drop impact strength, measured according to ASTM D1709-A, in the range from 350 to 550 g,
d) a haze value, determined according to ASTM D1003, in the range from 0.0 to 1.0%,
e) a clarity value, determined according to ASTM D1003, in the range from 98.0 to 100%, and
f) a 1.5 N Hot Tack sealing process window in the range from 20 to 30° C.

16. A process for producing the alpha-nucleated monophasic propylene terpolymer composition (PC) according to claim 9, comprising the steps of:
a) polymerizing propylene, ethylene and 1-butene comonomer units in a first polymerization reactor in the presence of a single-site catalyst to produce a first polymerization mixture comprising the first random terpolymer fraction (PP1) and the single-site catalyst;
b) withdrawing said first polymerization mixture from the first polymerization reactor and optionally carrying out steps c1) through c3) prior to step d)
c1) transferring the first polymerization mixture into a second polymerization reactor;
c2) polymerizing propylene, ethylene and 1-butene comonomer units in said second polymerization reactor in the presence of said single-site catalyst to produce a second polymerization mixture comprising the first random terpolymer fraction (PP1), the second random terpolymer fraction (PP2) and the single-site catalyst;
c3) withdrawing said second polymerization mixture from said second polymerization reactor; and
d) compounding the first polymerization mixture if steps c1) to c3) are not present, or the second polymerization mixture if steps c1) to c3) are present, with the one or more alpha nucleating agents (NU), optionally with a visbreaking agent (V) and optionally with the addition of further additives to form the alpha-nucleated monophasic propylene terpolymer composition (PC).

17. The alpha-nucleated monophasic propylene terpolymer composition (PC) according to claim 9, wherein the alpha-nucleated monophasic propylene terpolymer composition (PC) is obtainable via a process comprising the steps of:
a) polymerizing propylene, ethylene and 1-butene comonomer units in a first polymerization reactor in the presence of a single-site catalyst to produce a first polymerization mixture comprising the first random terpolymer fraction (PP1) and the single-site catalyst;
b) withdrawing said first polymerization mixture from the first polymerization reactor and optionally carrying out steps c1) through c3) prior to step d)
c1) transferring the first polymerization mixture into a second polymerization reactor;
c2) polymerizing propylene, ethylene and 1-butene comonomer units in said second polymerization reactor in the presence of said single-site catalyst to produce a second polymerization mixture comprising the first random terpolymer fraction (PP1), the second random terpolymer fraction (PP2) and the single-site catalyst;
c3) withdrawing said second polymerization mixture from said second polymerization reactor; and
d) compounding the first polymerization mixture if steps c1) to c3) are not present, or the second polymerization mixture if steps c1) to c3) are present, with the one or more alpha nucleating agents (NU), optionally with a visbreaking agent (V) and optionally with the addition of further additives to form the alpha-nucleated monophasic propylene terpolymer composition (PC).

18. An article comprising the alpha-nucleated monophasic propylene terpolymer composition (PC) according to claim 9 in an amount of at least 75 wt. %.

19. The article according to claim 18 being a blown film, having one or more of the following properties:
a) a sealing initiation temperature (SIT) in the range from 110 to 125° C.,
b) a Hot Tack Force, determined according to ASTM F1921-12-Method B, in the range from 2.0 to 5.0 N,
c) a dart drop impact strength, measured according to ASTM D1709-A, in the range from 40 to 60 g,
d) a haze value, determined according to ASTM D1003, in the range from 0.0 to 4.0%,
e) a clarity value, determined according to ASTM D1003, in the range from 98.0 to 100%, and
f) a 1.5 N Hot Tack sealing process window in the range from 15 to 25° C.

20. The article according to claim 13 being a cast film, having one or more of the following properties:
a) a sealing initiation temperature (SIT) in the range from 100 to 120° C.,
b) a Hot Tack Force, determined according to ASTM F1921-12-Method B, in the range from 2.0 to 5.0 N,
c) a dart drop impact strength, measured according to ASTM D1709-A, in the range from 350 to 550 g,
d) a haze value, determined according to ASTM D1003, in the range from 0.0 to 1.0%,
e) a clarity value, determined according to ASTM D1003, in the range from 98.0 to 100%, and
f) a 1.5 N Hot Tack sealing process window in the range from 20 to 30° C.
